(19) United States
(12) Patent Application Publication
(10) Pub. No.: US 2026/0189683 A1
(43) Pub. Date: Jul. 2, 2026

(54) NON-TRANSIENT PROCESSOR-READABLE MEDIA, PROJECTION SYSTEM, AND PROJECTING METHOD

(71) Applicant: Coretronic Corporation, Hsin-Chu (TW)

(72) Inventors: Chen-Ming Li, Hsin-Chu (TW); Yu-Ru Li, Hsin-Chu (TW); Chung-Lung Yang, Hsin-Chu (TW); Chia-Yen Ou, Hsin-Chu (TW); Yu-Wen Lo, Hsin-Chu (TW)

(73) Assignee: Coretronic Corporation, Hsin-Chu (TW)

(21) Appl. No.: 19/415,796

(22) Filed: Dec. 11, 2025

(30) Foreign Application Priority Data
Dec. 31, 2024 (CN) 202411978908.X
Oct. 21, 2025 (CN) 202511503179.7

(51) Int. Cl. H04N 9/31; G06F 3/0482; G06F 3/04847

(52) U.S. Cl. CPC H04N 9/3182; G06F 3/0482; G06F 3/04847

(57) ABSTRACT

The disclosure provides a non-transient processor-readable media, a projection system, and a projecting method. The non-transient processor may read a media storage application and execute the application to implement a user interface. The user interface includes: a projection device information area, a benchmark color information area, a captured color information area, and a start option. The projection device information area displays at least one projection device information. The projection device projects a display image. The benchmark color information area displays coordinate values of a benchmark color. The captured color information area displays coordinate values of a captured color. The start option receives a correction request. The processor generates and provides a color adjustment parameter value to the projection device to adjust a target color of the display image. In this way, the projection device may project the target color of the desired display image.

### CROSS-REFERENCE TO RELATED APPLICATION

This application claims the priority benefit of China application serial no. 202411978908.X filed on Dec. 31, 2024 and China application serial no. 202511503179.7 filed on Oct. 21, 2025. The entirety of the above-mentioned patent application is hereby incorporated by reference herein in its entirety and made a part of this specification.

### BACKGROUND

### Technical Field

The technical field relates to a non-transient processor-readable media, a projection system, and a projecting method.

### Description of Related Art

Projectors are increasingly being innovated in business, home, and education applications, and may be found in everything from traditional conference rooms to modern smart homes. In general, the advantage of projectors is that they may project large-size, high-resolution images, creating an immersive visual experience. Furthermore, projectors may display rich colors and provide a diverse visual experience. Therefore, whether watching movies, playing games, or giving presentations, projectors may bring a sense of immersion. In addition, the flexible settings of projectors allow the user to freely adjust the image size and position to meet the needs of different venues.

The colors of the images projected by a projector may deviate due to the reflective properties of the projection screen, the aging of the light source of the projector, or issues with the color wheel design or calibration, resulting in the projected image not matching the colors of the intended image. If color correction is inadequate, the image may not display the correct colors, thus affecting the viewing experience of the viewer. In addition, when using a plurality of projectors to form one large image, in application scenarios where the images projected by the plurality of projectors are partially overlapped or are side-by-side, it is necessary to adjust the colors of the images projected by the plurality of projectors to the desired colors.

In order for the projector to project an image with the target color, a colorimeter is used to measure the color of the projected image, thereby modifying the color of the projected image so that the projected image achieves the target color representation. However, since the measurement parameter values of the colorimeter are different from the internal color adjustment parameter values in the projector, adjustment may not be accurate.

When adjusting the colors projected by a projector, it is necessary to combine the human eye and the adjustment experience of the operator (e.g., the user) to determine whether the adjustment is appropriate. In other words, since this adjustment method requires repeated adjustments, measurements, and human judgment, this adjustment method relies on experience or instruction documents to perform. Furthermore, operators need to rely on their eyes or measured values from colorimeter to determine the color correction results in order to confirm whether the desired specifications are met, so that the color adjustment parameter values may not be quantified or the process may not be automated. In addition, this adjustment method may only make the colors of various solid color images (W/R/G/B/C/Y/M) as close as possible to the target color, but may not satisfy more detailed color correction, so that the color of the projected image may not be close to the color of the image signal content. Therefore, for those skilled in the art, how to make the projected image present the target color more conveniently is an important topic.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

A non-transient processor-readable media of an embodiment of the disclosure is installed on a computing device and used to store an application program. The computing device is communicatively connected to the projection device, and the computing device includes a processor, the processor is used to execute the application program to implement a user interface, and the user interface includes: a projection device information area, a benchmark color information area, a captured color information area, and a start option. The projection device information area is used to display at least one projection device information. The at least one projection device information includes information of the projection device. The projection device is used to project to form a display image on a projection target. The benchmark color information area displays coordinate values of a benchmark color. The captured color information area displays coordinate values of a captured color. The start option receives a correction request. In response to receiving a correction instruction corresponding to the correction request from the user interface, the processor generates a color adjustment parameter value according to the coordinate values of the benchmark color and the coordinate values of the captured color. The computing device is used to provide the color adjustment parameter value to the projection device to adjust a target color of the display image.

A projection system of an embodiment of the disclosure includes: a projection device and a computing device. The projection device is used to project to form a display image on a projection target. The computing device is communicatively connected to the projection device, and the computing device includes: a non-transient processor-readable media and a processor. The non-transient processor-readable media is used to store an application program. The processor is used to execute the application program to implement a user interface. The user interface includes: a projection device information area, a benchmark color information area, a captured color information area, and a start option. The projection device information area is used to display at least one projection device information, wherein the at least one projection device information includes information of the projection device. The benchmark color information area is used to display coordinate values of a benchmark color. The captured color information area displays coordinate values of a captured color. The start option is used to receive a correction request, wherein in response to receiving the correction request, the user interface provides a correction instruction to the processor. The processor generates a color adjustment parameter value according to the coordinate values of the benchmark color and the coordinate values of the captured color according to the correction instruction. The computing device is used to provide the color adjustment parameter value to the projection device to adjust a target color of the display image.

A projecting method of an embodiment of the disclosure is adapted to a projection system. The projection system includes a projection device, a benchmark projection device, a measuring device, and a computing device. Steps of the projecting method include: forming a target image corresponding to a benchmark color on a projection target by a projection of the benchmark projection device; forming a display image corresponding to a captured color on the projection target by a projection of the projection device; generating a benchmark color parameter value of the target image and a color parameter value of the display image respectively by measuring the target image and the display image via the measuring device; generating a luminosity adjustment parameter value based on a luminosity corresponding to the benchmark color parameter value and a luminosity corresponding to the color parameter value via the computing device in response to the benchmark color being white; providing the luminosity adjustment parameter value to the projection device via the computing device to adjust a target luminosity of the display image; generating a color adjustment parameter value based on the benchmark color parameter value and the color parameter value via the computing device in response to the benchmark color not being white; and providing the color adjustment parameter value to the projection device via the computing device to adjust a target color of the display image.

Other objectives, features and advantages of the present invention will be further understood from the further technological features disclosed by the embodiments of the present invention wherein there are shown and described preferred embodiments of this invention, simply by way of illustration of modes best suited to carry out the invention.

To make the foregoing easier to understand, a plurality of embodiments are described in detail below with reference to the figures.

### BRIEF DESCRIPTION OF THE DRAWINGS

FIG. 1 is a schematic diagram of a projection system according to an embodiment of the disclosure.

FIG. 2 is a schematic diagram of a color space according to an embodiment of the disclosure.

FIG. 3 is a schematic diagram of a user interface according to an embodiment of the disclosure.

FIG. 4A is a schematic diagram of a window according to an embodiment of the disclosure.

FIG. 4B is a schematic diagram of another window according to an embodiment of the disclosure.

FIG. 5 is a schematic flowchart of a color correction operation according to an embodiment of the disclosure.

FIG. 6 is a schematic diagram of a projection device according to an embodiment of the disclosure.

FIG. 7 is a schematic flowchart of a color correction operation according to an embodiment of the disclosure.

FIG. 8 is a schematic diagram of a transformation scenario of a color space according to an embodiment of the disclosure.

FIG. 9 is a schematic diagram of a color correction operation according to an embodiment of the disclosure.

FIG. 10 is a schematic diagram of a projection system according to an embodiment of the disclosure.

FIG. 11 is a schematic diagram of a color space according to an embodiment of the disclosure.

FIG. 12 is a schematic flowchart of a color correction operation according to an embodiment of the disclosure.

FIG. 13 is a schematic flowchart of a color correction operation according to an embodiment of the disclosure.

FIG. 14 is a schematic flowchart of a color correction operation according to an embodiment of the disclosure.

FIG. 15A is a schematic flowchart of a color correction operation according to an embodiment of the disclosure.

FIG. 15B is a schematic diagram of a color card according to an embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Unless limited otherwise, the terms “connected,” “coupled,” and “mounted,” and variations thereof herein are used broadly and encompass direct and indirect connections, couplings, and mountings. Accordingly, the drawings and descriptions will be regarded as illustrative in nature and not as restrictive.

Other objectives and advantages of the disclosure may be further understood from the technical features of the disclosure. The disclosure provides a non-transient processor-readable media and a projection system allowing the display image projected by the projection device to display the target color desired by the user, thereby enhancing viewing experience.

To address the existing issues, the disclosure proposes a technical solution. In the disclosure, the user interface may display the coordinate values of the benchmark color and the coordinate values of the captured color represented by the color parameter value generated by the measuring device. Furthermore, by the user operation on the user interface, the processor generates the color adjustment parameter value based on the coordinate values of the benchmark color and the coordinate values of the captured color. The computing device provides the color adjustment parameter value to the projection device. In this way, the display image projected by the projection device may present the target color, thereby enhancing viewing experience.

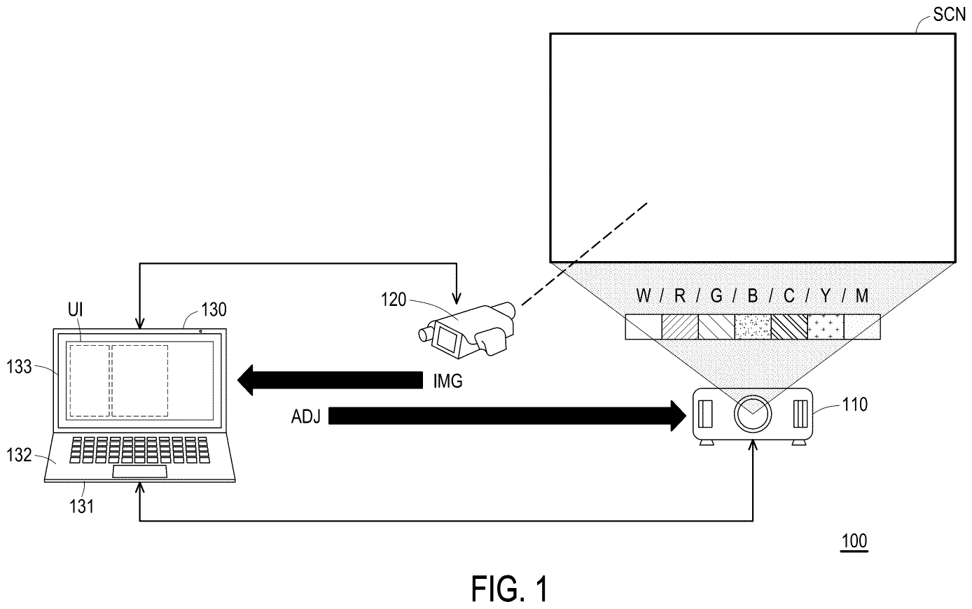

FIG. 1 is a schematic diagram of a projection system according to an embodiment of the disclosure. Please refer to FIG. 1. A projection system 100 of FIG. 1 includes a projection device 110, a measuring device 120, and a computing device 130. The computing device 130 includes a processor 131, a non-transient processor-readable media 132, and a display panel 133. The processor 131 is electrically connected to the non-transient processor-readable media 132 and the display panel 133, respectively. The computing device 130 may be communicatively connected to the projection device 110 and the measuring device 120, respectively. The computing device 130 is communicatively connected to the projection device 110 via a network cable (e.g., a CAT-5 cable). The computing device 130 is communicatively connected to the measuring device 120 via a Universal Serial Bus (USB). The processor 131 in the computing device 130 may be used to execute an application program or software to implement a user interface (UI), thereby displaying a user interface UI on the display panel 133 of the computing device 130. Via the user interface UI, the user may correct the color of a display image SCN projected by the projection device 110. The application program or software may be stored in the non-transient processor-readable media 132.

In an embodiment, the projection device 110 may be used to project a benchmark image light beam to form the display image SCN on a projection target. The projection target is, for example, a projection screen or a wall. For example, the projection device 110 may project a single-color image light beam (benchmark image light beam) onto the projection screen to form a single-color display image SCN. Furthermore, the measuring device 120 measures the color value of the display image SCN. The measuring device 120 may be used to generate a color parameter value IMG according to the color value and provide the color parameter value IMG to the computing device 130. Taking a camera as the measuring device 120 as an example, the camera captures a captured image containing the display image SCN, and the camera may provide the red value, the green value, and the blue value (i.e., R, G, B values) in the captured image as the color parameter value IMG to the computing device 130. The computing device 130 converts the R, G, B values in the captured image into X, Y values, x, y values, or u′, v′ values. In an embodiment, the measuring device 120 uses a colorimeter as an example. The colorimeter measures the X, Y values, x, y values, or u′, v′ values of the display image SCN as the color parameter value IMG. The colorimeter provides the color parameter value IMG to the computing device 130, and the computing device 130 may be used without transforming the color parameter value IMG. Those skilled in the art may know that the color parameter value, such as “X, Y values”, “x, y values” or “u′, v′ values”, refers to the representation methods used to describe the color value in different color spaces or chromaticity coordinate systems, and therefore is not elaborated further.

Then, the processor 131 in the computing device 130 generates the coordinate values of the captured color according to the color parameter value IMG. The processor 131 in the computing device 130 may display the benchmark color and the color (also known as the captured color) represented by the color parameter value IMG in the benchmark color information area and the captured color information area in the user interface UI, respectively. A detailed explanation will follow later in the article.

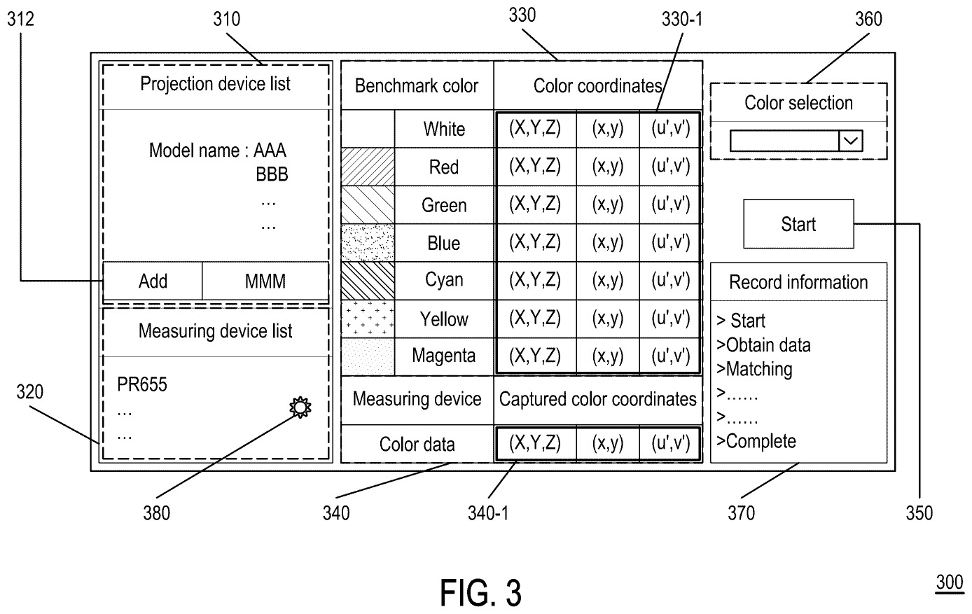

In addition, the user interface UI may include a start option (see FIG. 3 first for reference), and the start option may be used to receive a correction request. For example, the user may use various input methods (such as touch, keyboard, mouse, etc.) to click on the start option (such as the graphic option or the text option) on the user interface UI to make a correction request. Next, in response to receiving the correction request from the user, the user interface UI generates a correction instruction to the processor 131 to control the processor 131 of the computing device 130 to execute a color correction operation. Furthermore, the color correction operation is based on the captured color and the benchmark color to adjust the target color of the display image SCN. For example, the processor 131 may determine and generate a color adjustment parameter value ADJ based on the coordinate values of the captured color and the coordinate values of the benchmark color, and provide the color adjustment parameter value ADJ to the projection device 110. The projection device 110 may adjust the target color of the projected display image SCN based on the color adjustment parameter ADJ to correct the difference between the captured color and the benchmark color.

In this way, the user may readily make the display image SCN projected by the projection device 110 present the target color, thereby improving user experience.

In an embodiment, the projection device 110 may include a projector, and the disclosure does not limit the type of projector.

In an embodiment, the measuring device 120 is, for example, a colorimeter, a color difference meter, or a camera. The colorimeter is, for example, a reflective colorimeter, such as model PR-655. The camera may include a complementary metal-oxide-semiconductor (CMOS) camera, a charge-coupled device (CCD) camera, other similar devices, or a combination of the devices. However, the disclosure is not limited thereto.

In an embodiment, the computing device 130 may include a laptop, a tablet P C, a smartphone, other similar devices, or a combination of the devices. However, the disclosure is not limited thereto.

In an embodiment, the processor 131 of the computing device 130 may at least include a central processing unit (CPU), or other programmable general-purpose or special-purpose micro control unit (MCU), microprocessor, digital signal processor (DSP), programmable controller, application-specific integrated circuit (ASIC), graphics processing unit (GPU), image signal processor (ISP), image processing chip (IPC), arithmetic logic unit (ALU), complex programmable logic device (CPLD), field programmable gate array (FPGA), or other similar elements or a combination of the elements. However, the disclosure is not limited thereto.

In an embodiment, the non-transient processor-readable media 132 of the computing device 130 may at least include one or a plurality of combinations of static or mobile random-access memory (RAM), read-only memory (ROM), flash memory, hard disk, or any other similar device. However, the disclosure is not limited thereto. Furthermore, the non-transient processor-readable media 132 stores at least one application program, software, and/or program code that may be executed by the processor 131. For example, the processor 131 may access an application program stored in the non-transient processor-readable media 132 to execute the user interface UI to achieve the color correction operation provided in the disclosure.

In an embodiment, the display panel 133 of the computing device 130 is, for example, a liquid-crystal display panel or a light-emitting diode display panel, etc., and is not limited thereto. The display panel 133 may also include a touch panel, so that the display panel 133 may receive an operation request of a user on the user interface UI.

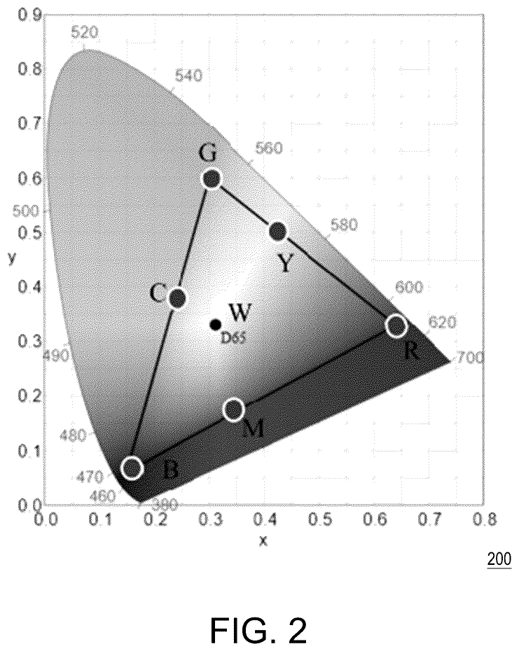

FIG. 2 is a schematic diagram of a color space according to an embodiment of the disclosure. Please refer to FIG. 1 and FIG. 2. In an embodiment, a color space 200 of FIG. 2 may be a benchmark color space. The color space 200 may include seven benchmark colors: white, red, green, blue, cyan, yellow, and magenta (W, R, G, B, C, Y, and M), which are the first to seventh benchmark colors, respectively.

In an embodiment, the user may set the first to seventh benchmark colors respectively via the user interface UI. In other words, the benchmark image light beam may be a pure color image light beam including one of the first to seventh benchmark colors.

It should be noted that if the first benchmark color (white) is selected as the benchmark color, the user interface UI may be used to make the computing device 130 adjust the current of the light source of the projection device 110, thereby adjusting the coordinate values of the target color on the display image SCN. In other words, adjusting the first benchmark color (white) means adjusting the luminosity value. Moreover, if one of the second to seventh benchmark colors is selected as the benchmark color, the user interface UI may be used to make the computing device 130 adjust the coordinate values of the target color of the display image SCN generated by the projection of the projection device 110.

For example, the user interface UI may be used to progressively correct the seven benchmark colors of the benchmark color space, thereby bringing the seven benchmark colors of the display image SCN closer to the ideal value. Furthermore, after gradually calibrating the seven benchmark colors of the benchmark color space, the user interface UI may be used to make the computing device 130 adjust other coordinate values of the benchmark color space, thereby making each color closer to the ideal value, thus achieving full color gamut correction. For detailed technical details regarding the color correction operation performed via the user interface UI of the disclosure, please refer to the descriptions of FIG. 3 to FIG. 9 below.

FIG. 3 is a schematic diagram of a user interface according to an embodiment of the disclosure. Please refer to FIG. 1 and FIG. 3. A user interface 300 of FIG. 3 is an implementation of the user interface UI of FIG. 1. However, the disclosure is not limited thereto. The user interface 300 includes a projection device information area 310, a measuring device information area 320, a benchmark color information area 330, a captured color information area 340, and a start option 350. Furthermore, the user interface 300 may include a benchmark color selection area 360, a recording information area 370, and a settings option 380.

In an embodiment, the benchmark color information area 330 is used to display the benchmark color. As mentioned earlier, the benchmark color may include the seven benchmark colors of the benchmark color space. The benchmark color information area 330 may display the seven benchmark colors of the benchmark color space and the coordinate values of the seven benchmark colors in various color spaces (e.g., (X, Y, Z) or (x, y) or (u′, v′)). The user may use the preset coordinate values of each benchmark color, or the user may manually input the coordinate values of each benchmark color as the coordinate values of the target color. The preset coordinate values of each benchmark color are stored in the non-transient processor-readable media 132.

In other words, the benchmark color information area 330 in the user interface 300 may include a target color input area 330-1, and the target color input area 330-1 is used to display the preset coordinate values of each benchmark color. In addition, the user may change or not change the preset coordinate values of the benchmark color. If the user modifies the preset coordinate values of at least one benchmark color in the target color input area 330-1, the user may customize the coordinate values of the at least one benchmark color. Furthermore, the processor 131 obtains the coordinate values of the target color of each benchmark color.

In addition, when changing the preset coordinate values of the benchmark color, the user needs to first provide a specified benchmark color request. The benchmark color selection area 360, for example, is a drop-down menu button, and may be used to receive the specified benchmark color request. Furthermore, in response to receiving the specified benchmark color request, the user interface 300 provides a specified benchmark color instruction to the processor 131, so that the processor 131 is used to execute an action modifying only the coordinate values of the specified benchmark color. For example, when the specified benchmark color request input by the user inputs is red, the processor 131 only allows modification of the coordinate value field of red in the target color input area 330-1, and the coordinate values of other benchmark color fields may not be modified.

In an embodiment, the start option 350 may be used to receive a correction request. Furthermore, in response to receiving a correction request, the user interface 300 generates a correction instruction corresponding to the correction request and transmits the correction instruction to the processor 131, so that the processor 131 executes a color correction operation. The color correction operation generates a color adjustment parameter value ADJ according to the coordinate values of the captured color and the coordinate values of the benchmark color, and adjusts the target color of the display image SCN.

The captured color information area 340 is used to display the coordinate values of the captured color, such as the coordinate values of the captured color in the color parameter value IMG. Furthermore, when the mode settings of the color correction operation is automatic mode, the user interface 300 may make the processor 131 execute: generating the color adjustment parameter value ADJ based on the color difference between the captured color and the benchmark color (e.g., the difference in coordinate values of the two in the same color space). Furthermore, the processor 131 may project a corrected display image SCN with the target color via the projection device 110, and determine whether the target state is reached or the color correction operation needs to be repeated based on the target color of the corrected display image SCN.

For example, the processor 131 may receive the color parameter value IMG via the measuring device 120. Furthermore, the processor 131 determines whether the color difference between the corrected captured color and the benchmark color (i.e., the difference in the new color coordinate values) is less than a preset color threshold. When the corrected color difference is less than the color threshold, the color correction reached the desired state. Moreover, when the color difference after correction is not less than the color threshold, the color correction has not yet reached the desired state, and the color correction operation is repeated again. In other words, in response to the color difference after correction being less than the color threshold, the processor 131 may be used to stop the color correction operation. Furthermore, in response to the corrected color difference not being less than the color threshold, the processor 131 may be used to repeat the color correction operation. The coordinate values of the captured color may be stored in the non-transient processor-readable media 132.

In an embodiment, the captured color information area 340 includes a captured color input area 340-1, and the user may input and modify the coordinate values of the captured color. For example, the user may modify the coordinate values of the captured color according to user experience. In an embodiment, the color represented by the coordinate values displayed in the captured color input area 340-1 is consistent with the color selected in the benchmark color selection area 360.

Additionally, the user interface 300 may include a recording information area 370, and the recording information area 370 may be used to display record information. The record information includes the progress of the color correction operation. In other words, by viewing the recording information area 370, the user may know the current status of the application program (or color correction). The record information may be stored in the non-transient processor-readable media 132.

In an embodiment, the projection device information area 310 may be used to display at least one projection device information (e.g., the model or the network address of the projection device 110). The at least one projection device information includes information of the projection device 110, and the projection device 110 is used to project to form the display image SCN on the projection target. Furthermore, the projection device information area 310 may display a projection device list. The projection device list may include at least one available projection device 110 (e.g., a first projection device AAA and a second projection device BBB), and the projection device list may be used to receive a specific projection device request from a user. In other words, the user may select at least one available projection device as the projection device 110 for color correction. In response to receiving the specified projection device request, the user interface 300 provides a specified projection device instruction to the processor 131, so that the processor 131 executes: setting the specified projection device (e.g., one of the first projection device AAA and the second projection device BBB) as the projection device 110 for color correction based on the specified projection device in the specified projection device instruction.

In addition, the projection device information area 310 may include an add projection device option 312, and the add projection device option 312 may be used to receive an add projection device request from the user. Moreover, in response to receiving the add projection device request, the user interface 300 provides an add projection device instruction to the processor 131, so that the processor 131 executes: adding a projection device to the projection device list based on the add projection device instruction (e.g., adding the third projection device MMM). In other words, the user may set the first projection device AAA, the second projection device BBB, or the third projection device MMM as the projection device 110 for color correction.

Similar to the projection device information area 310, the measuring device information area 320 may be used to display at least one measuring device information (e.g., the model or the network address of the measuring device 120). Furthermore, the measuring device information may include a measuring device list. The measuring device list may include at least one available measuring device 120 (e.g., a first measuring device PR655 and a second measuring device), and the user interface 300 may be used to receive a specified measuring device request from the user. In other words, the user may select the measuring device 120 to assist in the color correction operation. In response to receiving the specified measuring device request, the user interface 300 provides a specified measuring device instruction to the processor 131, so that the processor 131 executes: setting, for example, the first measuring device PR655 (specified measuring device) as the measuring device 120 used to assist in the color correction operation based on the specified measuring device in the specified measuring device instruction. In addition, the measuring device information area 320 may include the settings option 380 to set or add a measuring device.

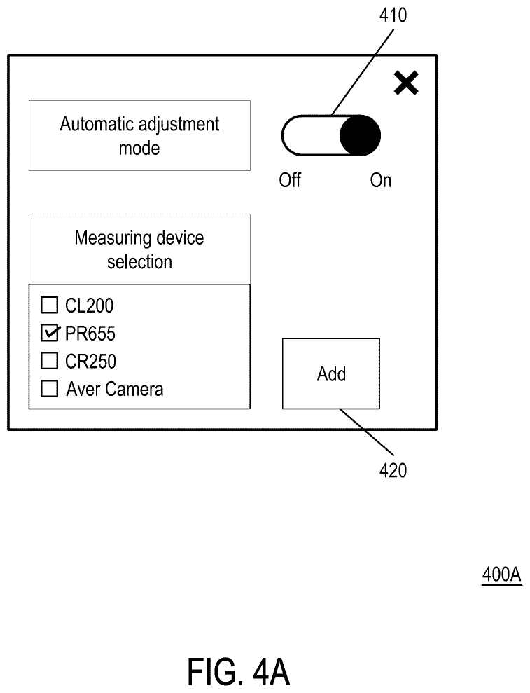

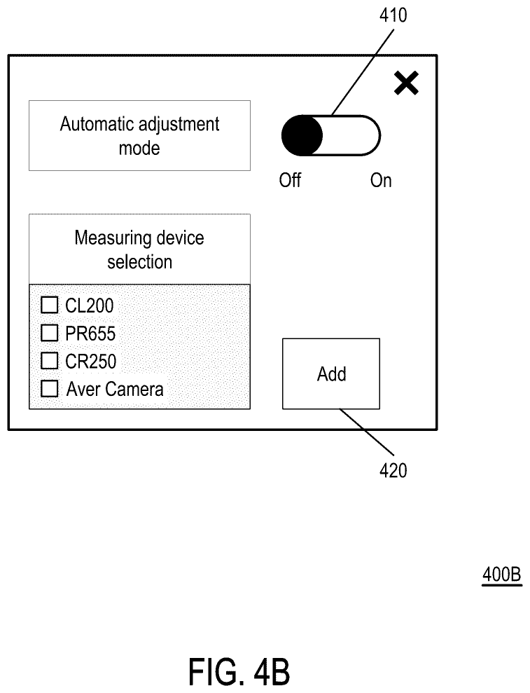

FIG. 4A is a schematic diagram of a window according to an embodiment of the disclosure. FIG. 4B is a schematic diagram of another window according to an embodiment of the disclosure.

Referring to FIG. 4A, the user may trigger the settings option 380 to make the user interface 300 display a window 400A. The window 400A may include an add measuring device option 420 to allows the user to add an additional measuring device.

In other words, the add measuring device option 420 may be used to receive an add measuring device request from the user. Furthermore, in response to receiving the add measuring device request, the window 400 of the user interface 300 provides an add measuring device instruction to the processor 131, so that the processor 131 executes: adding a measuring device (e.g., adding the third measuring device) to the measuring device list based on the add measuring device instruction. In other words, the user may choose one of the first measuring device, the second measuring device, or the third measuring device and set the above as the measuring device 120 used to assist in the color correction operation.

The user may select the measuring device 120 used to assist in the color correction operation through the window 400A. Specifically, the window 400A may include a selection option 410, and the selection option 410 corresponds to the on state or the off state of automatic adjustment mode. In response to the selection option 410 being in the on state, the processor 131 implements the automatic adjustment mode. The processor 131 of the computing device 130 generates the coordinate values of the captured color according to the color parameter value IMG generated by the measuring device 120, so that the captured color input area 340-1 automatically displays the coordinate values of the captured color, and the user may not change the coordinate values of the captured color.

Referring to FIG. 4B, in a window 400B, in response to the selection option 410 being in the off state, that is, the automatic adjustment mode is turned off and is in manual adjustment mode. In the manual adjustment mode, the user may not select the measuring device, and the processor 131 may not implement the automatic adjustment mode. The captured color input area 340-1 is used to manually input the coordinate values of the captured color. That is, the user may change the coordinate values of the captured color.

In the present embodiment, the processor 131 may repeatedly execute the color correction operation, automatically approximating the color of the display image SCN to the target color through an iteration computation. The iteration computation refers to a method of gradually approximating the target color by repeatedly executing the same calculation (or algorithm). For example, if the currently specified color to be corrected is red (i.e., the benchmark color selection area 360 selects red), then after the user triggers the start option 350, the processor 131 provides one red benchmark image signal to the projection device 110. Next, after receiving the benchmark image signal, the projection device 110 projects a red benchmark image light beam to form one red display image on the projection target. The measuring device 120 measures the color value of the red display image, and generates the color parameter value IMG, and transmits the above to the computing device 130. The processor 131 automatically performs the iteration computation according to the coordinate values of the captured color (red) represented by the color parameter value IMG and the coordinate values of the benchmark color (red) to generate the color adjustment parameter value ADJ and provide the above to the projection device 110 to implement color correction operation.

Moreover, when the mode settings of the color correction operation is manual mode (i.e., the selection option 410 is in off state), the user needs to input the coordinate values of the captured color in the captured color input area 340-1 through the user interface 300. Furthermore, the user may manually perform the color correction operation by inputting the target color coordinate values of the benchmark color in the target color input area 330-1 (i.e., filling in one of the three fields corresponding to (X, Y, Z) value, (x, y) value, or (u′, v′) value) based on the request of the desired adjustment of the target color of the display image SCN.

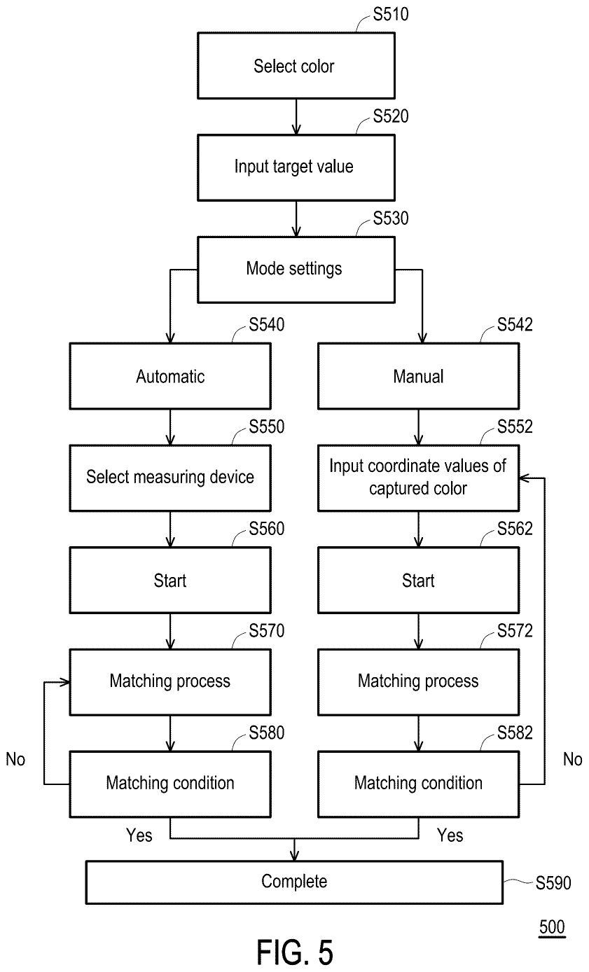

FIG. 5 is a schematic flowchart of a color correction operation according to an embodiment of the disclosure. Please refer to FIG. 1 to FIG. 5. A color correction operation 500 of FIG. 5 is an implementation of correcting the target color of the display image SCN on the projection device 110 using the user interface 300. In an embodiment, the color correction operation 500 includes step S510 to step S590.

In step S510, the user may select the color to be corrected as the benchmark color. For example, the user may choose one of the seven benchmark colors in the benchmark color space as the benchmark color. In step S520, the user may use the preset coordinate values of the benchmark color or manually input the coordinate values of the benchmark color as the coordinate values of the target color (i.e., the target value). To further explain, in the benchmark color information area 330 of the user interface 300, the processor 131 displays the preset coordinate values of the benchmark color as the coordinate values of the target color (i.e., the target value). Alternatively, in the benchmark color information area 330 of the user interface 300, the user may input the coordinate values of a custom benchmark color in the target color input area 330-1 as the coordinate values of the target color (i.e., the target value).

In step S530, the user interface 300 may display a window (e.g., the windows 400A and 400B) and make the setting of the captured color coordinate value in the automatic adjustment mode or the manual adjustment mode (i.e., the selection option 410 is in off state) via the selection option 410.

In step S540, referring to the window 400A, the user sets to automatic adjustment mode via the selection option 410. In step S550, the user may select the measuring device 120 used to measure the captured color of the projection device 110. The measuring device 120 provides the color parameter value IMG to the computing device 130. The processor 131 of the computing device 130 generates the coordinate values of the captured color and automatically displays the coordinate values of the captured color in the captured color input area 340-1 of the user interface 300. During this stage, the user may not change the coordinate values of the displayed captured color.

In step S560, by triggering the start option 350, the processor 131 begins to execute the color correction operation according to the correction instruction. In step S570, the processor 131 executes a matching process, and the matching process includes calculating the coordinate values of the benchmark color and the coordinate values of the captured color to generate a color difference. Following the matching process of step S570, in step S580, the processor 131 may confirm whether the color correction operation meets the termination condition. The termination condition includes whether the color difference is less than the color threshold. When the termination condition is not met, the processor 131 may return to step S570 and continue a new round of matching processing through iteration computation. Moreover, when the termination condition (the color difference is less than the color threshold) is met, the processor 131 executes step S590 to complete the color correction operation.

Moreover, in step S542, referring to the window 400B, the user sets to manual mode via the selection option 410 (i.e., the selection option 410 is in off state). In step S552, the user may not select the measuring device 120. The user may manually input the coordinate values of the captured color in the captured color input area 340-1 of the user interface 300. In step S562, by triggering the start option 350, the processor 131 begins to execute the color correction operation according to the correction instruction. In step S572, the processor 131 executed a matching process, and the matching process includes calculating the coordinate values of the benchmark color and the coordinate values of the captured color to generate a color difference. Following the matching process of step S572, in step S582, the processor 131 may confirm whether the color correction operation meets the termination condition. The termination condition includes whether the color difference is less than the color threshold. When the termination condition is not met, the processor 131 may return to step S552, and the user may input new coordinate values of the captured color to continue a new round of matching processing. Moreover, when the termination condition (the color difference is less than the color threshold) is met, the processor 131 executes step S590 to complete the color correction operation.

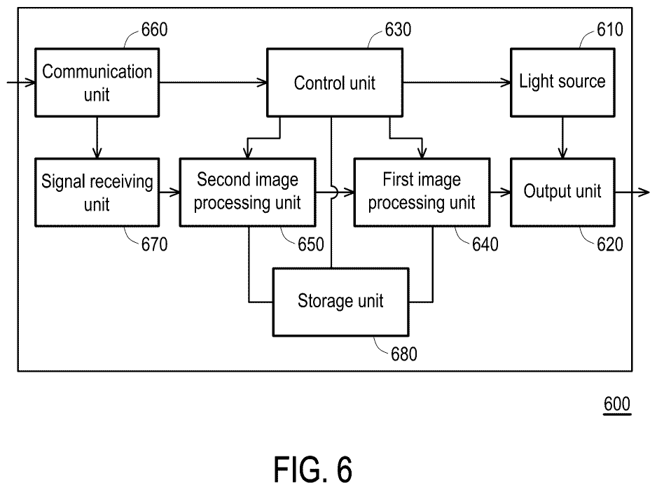

FIG. 6 is a schematic diagram of a projection device according to an embodiment of the disclosure. Please refer to FIG. 1 and FIG. 6. A projection device 600 of FIG. 6 is an implementation of the projection device 110 of FIG. 1. However, the disclosure is not limited thereto. The projection device 600 at least includes a light source 610, an output unit 620, a control unit 630, a first image processing unit 640, a second image processing unit 650, a communication unit 660, a signal receiving unit 670, and a storage unit 680. The control unit 630 is coupled to the communication unit 660, the light source 610, the first image processing unit 640, the second image processing unit 650, and the storage unit 680, respectively. The signal receiving unit 670 is coupled to the communication unit 660 and the second image processing unit 650. The first image processing unit 640 is coupled to the second image processing unit 650, the storage unit 680, and the output unit 620. The storage unit 680 is coupled to second image processing unit 650. The storage unit 680 may include at least one or a plurality of combinations of static or mobile random-access memory (RAM), read-only memory (ROM), flash memory, hard disk, or any other similar device. However, the disclosure is not limited thereto.

In an embodiment, the light source 610 is used to provide an illumination light beam. The light source 610 at least includes, for example, at least one laser diode or at least one light-emitting diode (LED diode). The output unit 620 at least includes a light valve and a projection lens. The light valve is, for example, a reflective light modulator such as a digital micro-mirror device (DMD) and a liquid crystal on silicon panel (LCoS panel), or a transmissive light modulator such as a transmissive liquid crystal panel (LC panel), but is not limited thereto. The light valve is used to receive the illumination light beam and convert the illumination light beam into an image light beam. The projection lens is disposed in the transmission path of the image light beam and used to project the image light beam out of the projection device 110. The projection lens includes, for example, a combination of one or a plurality of optical lenses with refractive power (diopter), such as various combinations of non-planar lenses such as biconcave lenses, biconvex lenses, concave-convex lenses, convex-concave lenses, plano-convex lenses, and plano-concave lenses.

In an embodiment, the communication unit 660 is used to receive a signal from the computing device 130 wirelessly or via wire (e.g., at least one of a benchmark image signal of a projected benchmark image light beam and the color adjustment parameter value ADJ). In the present embodiment, the communication unit 660 receives at least one of the benchmark image signal and the color adjustment parameter value ADJ from the computing device 130 via a network cable (e.g., a CAT-5 cable). The communication unit 660 is, for example, a wireless network circuit or a wireless network chip, a wired network circuit or a wired network chip, or a combination of the above circuits or chips. In an embodiment, the communication unit 660 may be, for example, a circuit or a chip supporting Global System for Mobile Communication (GSM), a circuit or chip supporting Wireless Fidelity (WiFi), or a circuit or a chip supporting Bluetooth communication technology, or a combination thereof, and is not limited thereto. Furthermore, through the communication unit 660, the signal receiving unit 670 may receive an image signal (such as a benchmark image signal) from the computing device 130. The signal receiving unit 670 may be, for example, an image processing chip or an image processing circuit, or a combination thereof, and is not limited thereto. In an embodiment, the benchmark image signal is correlated with the coordinate values of the benchmark color.

In an embodiment, the control unit 630 receives the color adjustment parameter value ADJ from the communication unit 660. The second image processing unit 650 receives the color adjustment parameter value ADJ provided by the control unit 630 and the benchmark image signal provided by the signal receiving unit 670. The first image processing unit 640 receives the color adjustment parameter value ADJ provided by the control unit 630 and the benchmark image signal provided by the second image processing unit 650.

The control unit 630 is used to adjust the current of the light source 610 based on the color adjustment parameter value ADJ, thereby adjusting the luminosity value of the display image SCN. Furthermore, the first image processing unit 640 is used to adjust the target color of the display image SCN based on the benchmark image signal and/or the color adjustment parameter value ADJ. In addition, the second image processing unit 650 is used to correct the target color of the display image SCN based on the benchmark image signal and/or the color adjustment parameter value ADJ, and the color transformation look up table (CTLUT). In other words, the control unit 630 may be used to correct the white (W) of the benchmark color space, which is to correct the luminosity value of the display image. The first image processing unit 640 may be used to correct the red (R), green (G), blue (B), cyan (C), yellow (Y) and magenta (M) of the benchmark color space. The second image processing unit 650 is used to correct other colors in the benchmark color space, thereby achieving the effect of full color gamut area correction.

In an embodiment, the first image processing unit 640 is, for example, a Texas Instruments Digital Display Processor (DPP) or a chip or a circuit with the same function, or a combination thereof, and is not limited thereto. The second image processing unit 650 is, for example, a scaler integrated circuit (Scaler IC) or a field programmable gate array (FPGA) or a chip or a circuit with the same function, or a combination thereof, and is not limited thereto. In addition, the color transformation look up table may be stored in the storage unit 680, and the second image processing unit 650 is used to access the color transformation look up table.

In an embodiment, please refer to in FIG. 3 and FIG. 6. After the processor 131 executes the application program, the display panel 133 of the computing device 130 displays the user interface 300. By operating the user interface 300, the user may perform the following color correction operation of the display image SCN. First, the projection device 110 automatically adjusts the projected benchmark color light beam according to the benchmark image signal to match the preset coordinate values of the benchmark color or the coordinate values of the benchmark color manually input by the user. The measuring device 120 measures the display image SCN and sends the color parameter value IMG back to the computing device 130. After receiving the color parameter value IMG, the computing device 130 calculates and generates the coordinate values of the captured color, or the user manually inputs the coordinate values of the captured color in the captured color input area 340-1 of the user interface 300. The coordinate values of the captured color are obtained by the processor 131 based on a pre-established transformation matrix, transforming the format of the captured color, such as “X, Y”, “x, y”, “u′, v′”, into coordinate values, such as “H, S”. Furthermore, the processor 131 calculates and generates the color adjustment parameter value ADJ according to the coordinate values of “H, S” and the coordinate values of luminosity (the corresponding benchmark color is white), in order to adjust the luminosity value and the color change value of the display image SCN. The processor 131 provides the color adjustment parameter value ADJ to the first image processing unit 640 and the control unit 630 of the projection device 110 to adjust the “H, S values” of the display image SCN and the luminosity value of the display image SCN. The spatial transformation matrix is stored in the non-transient processor-readable media 132, and the processor 131 may access the spatial transformation matrix.

Since the change in the coordinate values of the colors in the spatial transformation matrix corresponds to the change in the “H and S values” in a non-linear manner, the color correction operation above needs to be repeated, meaning repeatedly projecting the benchmark colors of the benchmark image light beam, such as R, G, B, C, Y, and M colors. Through iteration computation, a spatial transformation matrix may be established until the processor 131 determines the coordinate values of the captured color of the projected display image SCN are close to the coordinate values of the target color to be adjusted. The spatial transformation matrix is used to convert the coordinate values of the captured color in formats such as “X, Y”, “x, y”, “u′, v′” to coordinate values in a color format such as “H, S”.

As mentioned above, the adjustment of the color correction operation is typically one iterative approximation computation process. In practice, the color correction operation may first correct the seven benchmark colors of the benchmark color space, and then correct the other colors. For example, the projection device 110 may project a benchmark image light beam of a benchmark color at a time, and perform iteration computation and correction of the benchmark color through the color correction operation. In addition, if a plurality of different benchmark colors are selected for correction, the color correction operation of the next benchmark color needs to be performed after one benchmark color is finished correcting (for example, approaching the target value).

In general, when performing the color correction operation, white (W) is first used as the benchmark color for correction to adjust the luminosity of the light source 610 in the projection device 110. Then, the measuring device 120 sequentially obtains the measurement values of the display image of each benchmark color projected by the projection device 110. The processor 131 may convert the measurement values into the coordinate values of the captured color to confirm the difference between the measurement values and the target value, and calculate the color adjustment parameter value ADJ used to adjust the “H, S, G values” of the projection device 120 to bring the measurement values closer to the target value. After performing the color correction operation on each benchmark color, it may be determined that the adjustment of the first image processing unit 640 is complete. In other words, after the adjustment of the first image processing unit 640 is completed, the R, G, B, C, M and Y values of the benchmark color space may be approximated to the target value. Next, the color correction operation may be performed on colors other than the seven benchmark colors, and based on the color transformation look up table, each level of color may be made closer to the target value, thereby achieving an effect close to full color gamut area correction.

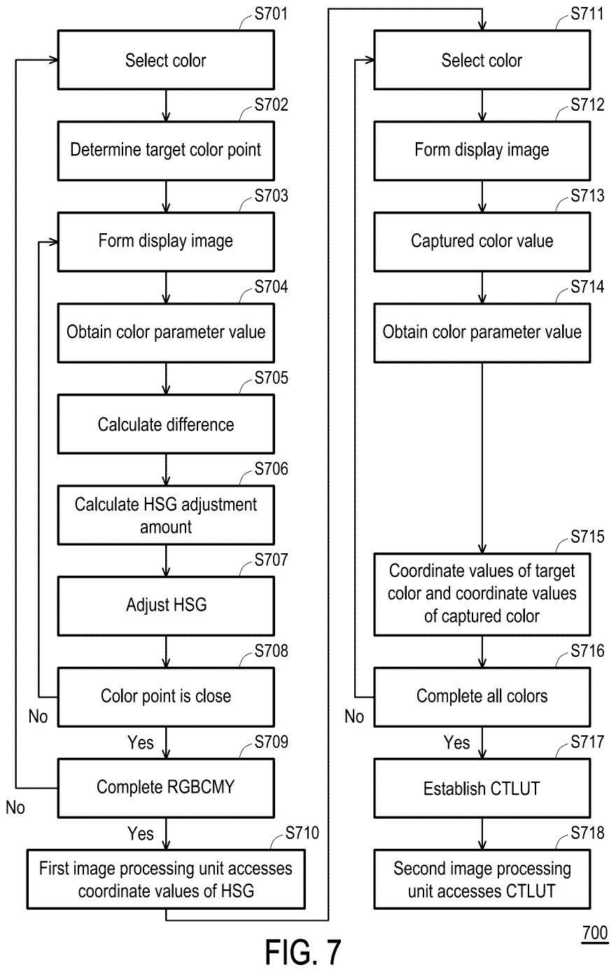

FIG. 7 is a schematic flowchart of a color correction operation according to an embodiment of the disclosure. Please refer to FIG. 1, FIG. 3, FIG. 6, and FIG. 7. A color correction operation 700 of FIG. 7 is a method of establishing a color transformation look up table. However, the disclosure is not limited thereto. In an embodiment, the color correction operation 700 may include step S701 to step S718.

First, the color correction operation may correct the W, R, G, B, C, M, and Y of the benchmark color space. In general, white (W) is used as the benchmark color for correction first, and then other benchmark colors are corrected. In step S701, the user may select the color he wants to correct as the benchmark color. In step S702, the processor may determine the coordinate values of the target color (i.e., the target color point) based on the preset coordinate values of the benchmark color or the coordinate values input by the user through the signal received via the user interface UI. In step S703, the processor 131 may make the projection device 110 project a benchmark image light beam corresponding to the benchmark color based on the coordinate values of the target color to form the display image SCN on the projection target.

In step S704, the measuring device 120 may capture color values containing the display image SCN to generate the color parameter values IMG, and provide the color parameter values IMG to the processor 131. In step S705, the processor 131 executes a calculation of the coordinate values of the captured color and the coordinate values of the benchmark color to generate a color difference. In step S706, based on the spatial transformation matrix, the coordinate values of the color difference in the format of, for example, “X, Y”, “x, y”, “u′, v′”, are transformed into the coordinate values of “H, S, G”. In step S707, the processor 131 adjusts the coordinate values of “H, S, G” through iteration computation. In step S708, the processor 131 determines whether the color points (i.e., coordinate values of the color) of the two are close, that is, whether the adjusted color difference is less than the color threshold. If not, repeat step S703. If so, proceed to step S709.

In step S709, the processor 131 determines whether the R, G, B, C, M and Y colors of the benchmark color space are all corrected. If not, return to step S701 to continue correcting the benchmark color for which correction is not completed. If so, proceed to step S710: the first image processing unit 640 stores the corrected coordinate values of “H, S, G” in the storage unit 680 of the projection device 110 for subsequent access and use.

In step S711, the user may select colors W, R, G, B, C, M, and Y different from the benchmark color space as the target color. In step S712, the projection device 110 may project an image light beam corresponding to the target color to form the display image SCN.

In step S713, the measuring device 120 may capture color values containing the display image SCN to generate the color parameter value IMG. In step S714, the measuring device 120 provides the color parameter value IMG to the processor 131 so that the processor 131 may obtain the color parameter value IMG. In step S715, the processor 131 records the coordinate values of the current target color and the coordinate values of the captured color. In step S716, the processor 131 confirms whether all colors to be corrected are completed. If not, return to step S711 to record for other colors. If so, step S717 is performed.

In step S717, the processor 131 establishes a color transformation look up table based on all the recorded data. Furthermore, the processor 131 may provide the color transformation look up table to the projection device 110. In step S718, the second image processing unit 650 may access the established color transformation look up table.

In an embodiment, the projection device 600 may adjust the current of the light source through the control unit 630 to achieve the correction of the coordinate values of white (W). Furthermore, the projection device 600 may correct the coordinate values of R, G, B, C, M, and Y through the first image processing unit 640. For example, the projection device 600 may sequentially project benchmark image light beams of pure colors with benchmark colors R, G, B, C, M, and Y, and store the coordinate values of the colors. It should be noted that the range enclosed by the coordinate values of R, G, B, C, M, and Y represents the color range output by the entire projection device 600. Furthermore, the projection device 600 may sequentially project pure color image light beams of colors other than R, G, B, C, M, Y, and store the coordinate values of the colors to establish the above color transformation look up table.

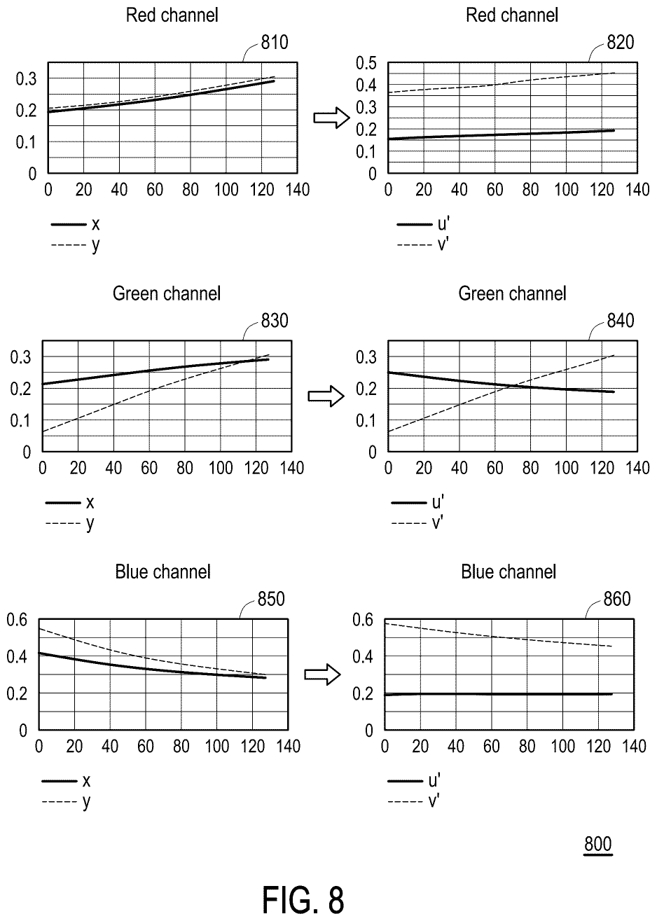

FIG. 8 is a schematic diagram of a transformation scenario of a color space according to an embodiment of the disclosure. Please refer to FIG. 1 and FIG. 8. A transformation scenario 800 of a color space of FIG. 8 includes a red channel 810, a green channel 830, and a blue channel 850 represented in (x, y) coordinates of the color space. Furthermore, the transformation scenario 800 of the color space of FIG. 8 further includes a red channel 820, a green channel 840, and a blue channel 860 represented by (u′, v′) coordinates.

It should be noted that the color adjustment parameter value ADJ of the projection device is in the format of “H, S, G values” (i.e., hue, saturation, gain) and not “X, Y values”, “x, y values”, “u′, v′ values” or “R, G, B values”. Therefore, when performing the color correction operation on the projection device 110, it is necessary to transform the coordinate values of different color spaces of the color parameter value IMG into the coordinate values of “H, S, G”.

For example, please refer to the red channel 810 represented by (x, y) coordinates and the red channel 820 represented by (u′, v′) coordinates. When the “H and S values” of the projection device 110 are changed, the “x and y values” of the red channel 810 are both changed more significantly. Moreover, when the “H and S values” of the projection device 110 are changed, only the “v′ value” of the red channel 820 is changed more significantly, but the “u′ value” is changed more gradually. In other words, for red color, using the red channel 810, represented by (x, y) coordinates, as a benchmark to adjust the “H, S values” of the projection device 110 achieves a more accurate effect.

Similarly, please refer to the green channel 830 represented by (x, y) coordinates and the green channel 840 represented by (u′, v′) coordinates. When the “H and S values” of the projection device 110 are changed, the “x and y values” of the green channel 830 are both changed more significantly. Moreover, when the “H and S values” of the projection device 110 are changed, the “u′ and v′ values” of the green channel 840 are both changed more significantly. In other words, for green color, using the green channel 830 represented by (x, y) coordinates or the green channel 840 represented by (u′, v′) coordinates as a benchmark to adjust the “H, S values” of the projection device 110 may both achieve good effect.

Lastly, please refer to the blue channel 810 represented by (x, y) coordinates and the blue channel 820 represented by (u′, v′) coordinates. When the “H and S values” of the projection device 110 are changed, the “x and y values” of the blue channel 810 are gradually levelled off (i.e., changed less) as the “H and S values” are changed. Moreover, when the “H and S values” of the projection device 110 are changed, only the “v′ value” of the blue channel 820 is changed significantly, but the “u′ value” is changed more gradually. In other words, for blue color, using the blue channel 860, represented by (u′, v′) coordinates, as a benchmark to adjust the “H, S values” of the projection device 110 achieves a more accurate effect.

In other words, for different colors, different coordinate systems (i.e., coordinate systems with greater variation) may be selected as the benchmark for adjusting the “H and S values” of the projection device 110 to obtain a more accurate effect. Furthermore, within the same coordinate system, the correction direction with the more significant change may be selected for adjustment, thereby observing a more significant change.

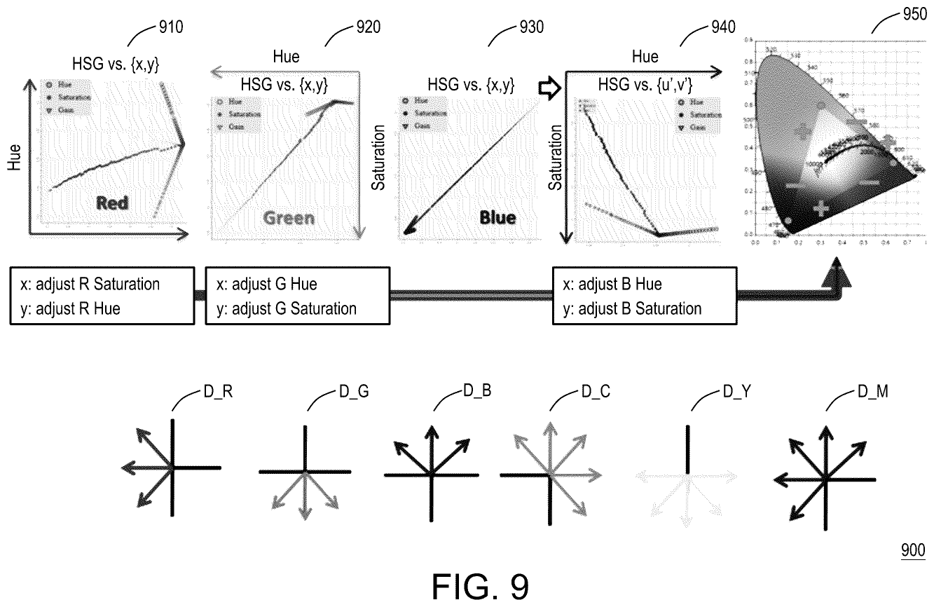

FIG. 9 is a schematic diagram of an adjustment scenario of a color correction operation according to an embodiment of the disclosure. Please refer to FIG. 1, FIG. 8, and FIG. 9. FIG. 9 illustrates an adjustment scenario 900 of the color correction operation, similar to that shown of FIG. 8: the influence of the correction direction on the color correction operation. In an embodiment, the adjustment scenario 900 includes color change diagrams 910 to 930 of red, green, and blue in (x, y) coordinates, a color change diagram 940 of blue in (u′, v′) coordinates, and a color point trajectory diagram 950. In addition, the adjustment scenario 900 includes correction directions D_R, D_G, D_B, D_C, D_Y, and D_M.

As discussed of FIG. 8, the adjustment of red may adopt the color change diagram 910 represented by (x, y) coordinates. Furthermore, for the adjustment of green, the color change diagram 920 represented by (x, y) coordinates (or (u′, v′) coordinates) may be adopted. However, for the adjustment of blue, it is more difficult to see the change in color if the color change diagram 930 represented by (x, y) coordinates is adopted. Therefore, for the adjustment of blue, the color change diagram 940, represented by (u′, v′) coordinates, may be adopted instead. In addition, the color point trajectory diagram 950 illustrates the trajectory of a possible change in the color point when adjusting the color.

In addition, please refer to the benchmark color space (e.g., the color point trajectory diagram 950 or the color space 200) and the correction directions D_R, D_G, D_B, D_C, D_Y and D_M. The correction directions D_R, D_G, D_B, D_C, D_Y, and D_M may respectively represent the correction directions of R, G, B, C, Y, and M approximating the benchmark color space.

In the benchmark color space, red is located at the far right of the benchmark color space. In other words, the correction direction D_R of red may only be to the left (e.g., top left, straight left, bottom left). Similarly, green is located at the top of the benchmark color space. In other words, the correction direction D_G of green may only be downward (e.g., lower left, straight down, lower right). Similarly, blue is located at the bottom of the benchmark color space. In other words, the correction direction D_B of blue may only be upward (e.g., upper left, straight up, upper right). Based on the above logic, the correction direction D_C of cyan, the correction direction of D_Y of yellow, and the correction direction of D_M of magenta may be determined respectively.

Therefore, when different benchmark colors are used as the target colors of the color correction operation, appropriate directions may be selected for the color correction operation to achieve better results. In other words, the processor of the computing device 130 may be used to determine the correction direction in the benchmark color space according to the benchmark color.

In an embodiment, the projection system may further include a plurality of projection devices, and the plurality of projection devices may select the coordinate values of the same benchmark color and each make the plurality of display images generated by the projection of the plurality of projection devices have consistency in color and luminosity through the color correction operation to improve user experience.

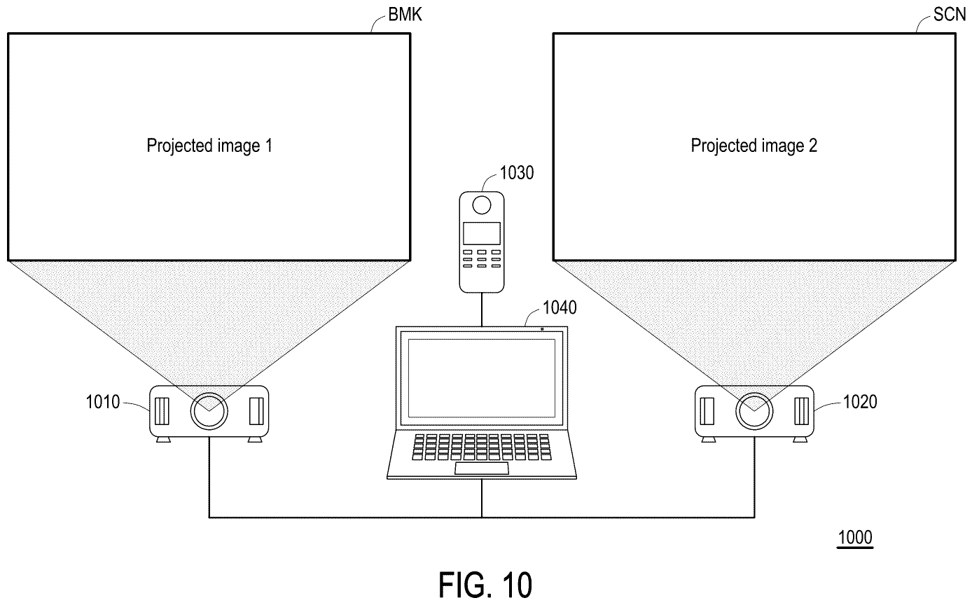

FIG. 10 is a schematic diagram of a projection system according to an embodiment of the disclosure. Please refer to FIG. 10. A projection system 1000 of FIG. 10 includes a measuring device 1030 and a computing device 1040. The implementation details of a projection device 1010, a projection device 1020, the measuring device 1030, and the computing device 1040 may be found in the description of the projection device 110, the measuring device 120, and the computing device 130 of FIG. 1, and are not be repeated here.

In an embodiment, the projection device 1010 and the projection device 1020 may be used to project an image light beam respectively to form a projection image 1 and a projection image 2 on the projection target. The projection target is, for example, a projection screen or a wall. There is no functional difference between the projection device 1010 and the projection device 1020. The difference is that the projection device 1010 (or another projection device) may be used as a benchmark projection device for color correction by the projection device 1020. The projection device 1010 is used to form a target image BMK corresponding to the benchmark color on the projection target, and the projection device 1020 is used to form the display image SCN corresponding to the captured color on the projection target. Therefore, the projection image 1 may be called the target image BMK, and the projection image 2 may be called the display image SCN.

The measuring device 1030 may be communicatively connected to the computing device 1040 and is used to measure the color values of the target image BMK and the color values of the display image SCN to generate the benchmark color parameter value of the target image BMK corresponding to the projection device 1010 and the color parameter value IMG of the display image SCN corresponding to the projection device 1020, respectively. Then, the measuring device 1030 provides the benchmark color parameter value and the color parameter value IMG to the processor (not shown) of the computing device 1040, so that the computing device 1040, in response to the correction instruction, performs color space transformation (i.e., transforms into the same color space) on the benchmark color parameter value and the color parameter value IMG to respectively calculate the coordinate values of the captured color corresponding to the benchmark color parameter value and the coordinate values of the captured color corresponding to the color parameter value IMG, and uses the coordinate values of the captured color corresponding to the benchmark color parameter value as the coordinate values of the benchmark color.

Specifically, the user interface UI may be used to make the processor of the computing device 1040 execute: using the captured color of the projection device 1010 as the benchmark color. For the projection device 1020, the coordinate values of the benchmark color are used as the benchmark to the coordinate values of the captured color of the target image BMK of the projection device 1010 captured by the measuring device 1030, thereby performing color correction. For example, in response to the processor of the computing device 1040 receiving the correction instruction, the processor executes:
generating a color difference based on the coordinate values of the captured color and the coordinate values of the benchmark color, and generating the color adjustment parameter value ADJ for color correction based on the color difference. Next, the computing device 1040 may be used to provide the color adjustment parameter value ADJ to the projection device 1020 to adjust the target color of the display image SCN. In this way, the color of the target image BMK projected by the projection device 1010 and the color of the display image SCN projected by the projection device 1020 may achieve consistent color performance, thereby enhancing viewing experience.

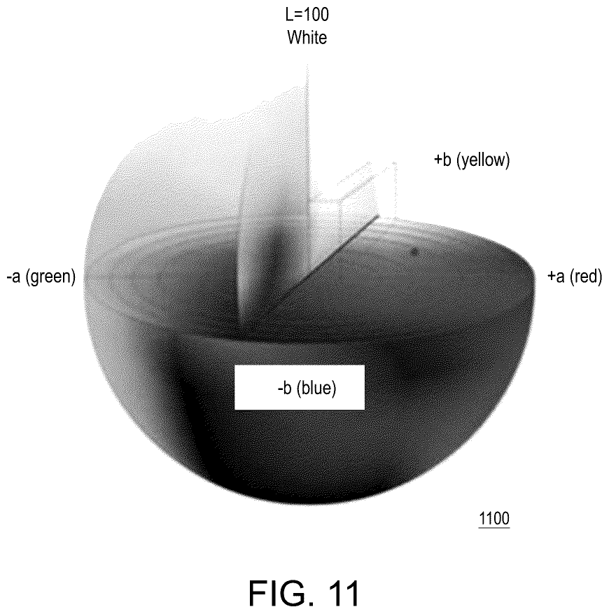

FIG. 11 is a schematic diagram of a color space according to an embodiment of the disclosure. FIG. 11 is a color space diagram familiar to those skilled in the art. Please refer to FIG. 10 and FIG. 11. In an embodiment, a color space 1100 of FIG. 11 may be the Lab color space. More specifically, the Lab color space consists of three axes (i.e., L, a, b). The L-axis represents luminance, the a-axis represents chromaticity from green to red, and the b-axis represents chromaticity from blue to yellow. The purpose of the Lab color space design is to better present the color differences perceived by the human eye. Therefore, if the Lab color space is used to perform color correction on the projected images of a plurality of projection devices (e.g., the projection device 1010 and the projection device 1020), the colors of the images may be adjusted more accurately.

In other words, when performing color correction on the projected image formed by the projection of the plurality of projection devices, the processor of the computing device 1040 may transform the benchmark color parameter value of the corresponding projection device 1010 and the color parameter value IMG of the corresponding projection device 1020 into the Lab color space to generate the coordinate values of the benchmark color and the coordinate values of the captured color of the corresponding projection device 1020, respectively. The processor of the computing device 1040 may generate a color difference based on the coordinate values of the benchmark color in the Lab color space and the coordinate values of the captured color, thereby generating the color adjustment parameter value ADJ for color correction, and provide the color adjustment parameter value ADJ to the projection device 1020 to adjust the target color of the display image SCN. In this way, the color of the target image BMK formed by the projection of the projection device 1010 and the color of the display image SCN formed by the projection of the projection device 1020 may achieve consistent color performance under the perception of the human eye, thereby enhancing viewing experience.

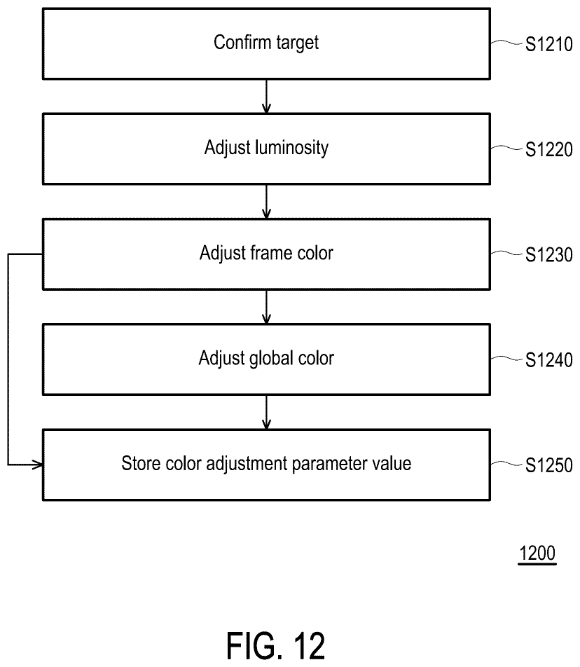

FIG. 12 is a schematic flowchart of a color correction operation according to an embodiment of the disclosure. Please refer to FIG. 10 to FIG. 12. A color correction operation 1200 of FIG. 12 is an implementation of correcting the target color of the display image SCN of the projection device 1020 via the computing device 1040. In an embodiment, the color correction operation 1200 includes step S1210 to step S1250. However, the disclosure is not limited thereto.

In step S1210, the processor of the computing device 1040 identifies the target (i.e., the benchmark) for color correction. For example, in the plurality of projection devices of the projection system 1000, the projection device 1010 may be confirmed as the benchmark projection device and is used as the target for color correction of the projection device 1020.

In step S1220, the processor of the computing device 1040 adjusts the luminosity of the display image SCN formed by the projection of the projection device 1020 (i.e., using white as the benchmark color). It should be noted that the human eye is most sensitive and noticeable to differences in luminosity of color perception. Therefore, when performing color correction, luminosity should be adjusted first. When the luminosity of the target image BMK is consistent with the luminosity of the display image SCN formed by the projection of the projection device 1020, under the perception of the human eye, the sensitivity to color differences is significantly reduced.

In step S1220, the processor of the computing device 1040 adjusts the display image SCN using white as the benchmark color. For example, the processor generates the luminosity adjustment parameter value based on the luminosity corresponding to the benchmark color parameter value and the luminosity corresponding to the color parameter value IMG. Specifically, the processor generates the luminosity difference based on the luminosity corresponding to the coordinate values of the captured color and the luminosity corresponding to the coordinate values of the benchmark color. The processor generates the luminosity adjustment parameter value based on the luminosity difference and provides the luminosity adjustment parameter value to the projection device 1020 to adjust the target luminosity of the display image SCN. After step S1220 is completed, in response to the white of the display image SCN finishing adjusting, step S1230 is executed, so that the processor adjusts the display image SCN using red, green, blue, cyan, yellow, and magenta as the benchmark color respectively (i.e., the benchmark color is not white).

In step S1230, the processor of the computing device 1040 adjusts the frame color of the display image SCN formed by the projection device 1020. It should be noted that, referring to FIG. 2, the benchmark color space may include seven benchmark colors: white, red, green, blue, cyan, yellow, and magenta. After removing white (to adjust luminosity), the remaining 6 benchmark colors may be called frame colors. More specifically, the frame colors define the frame (i.e., boundaries, extrema) of one color space. Therefore, when performing color correction, by first establishing the framework of the color space and then correcting other colors (such as the global color in the color space), the effect of the color correction is more accurate.

For example, the processor generates the color adjustment parameter value ADJ based on the benchmark color parameter value and the color parameter value IMG, and provides the color adjustment parameter value ADJ to the projection device 1020 to adjust the target color of the display image SCN. In detail, the processor may generate a color difference based on the coordinate values of the captured color and the coordinate values of the benchmark color, and generate the color adjustment parameter value ADJ based on the color difference.

In step S1240, the processor of the computing device 1040 adjusts the global color of the display image SCN formed by the projection of the projection device 1020. As mentioned earlier, once the framework of the color space is established, other colors may be adjusted to achieve full color gamut color correction. In other words, global color refers to other colors other than the seven benchmark colors. Furthermore, the number of global colors may be increased or decreased as needed, and the disclosure does not impose any limitations in this regard. Incidentally, when the requirements for color are relatively lenient, step S1240 may be omitted. In other words, after completing step S1230, step S1250 may be executed directly. In this way, the time needed for color correction operation 1200 is reduced, thus achieving the color correction effect quickly.

In step S1250, the processor of the computing device 1040 stores the color adjustment parameter value ADJ calculated in step S1220 to step S1240, and provides the color adjustment parameter value ADJ to the projection device 1020 to adjust the target color of the display image SCN.

In this way, the color of the target image BMK formed by the projection of the projection device 1010 and the color of the display image SCN formed by the projection of the projection device 1020 may achieve consistent color performance under the perception of the human eye, thereby enhancing viewing experience.

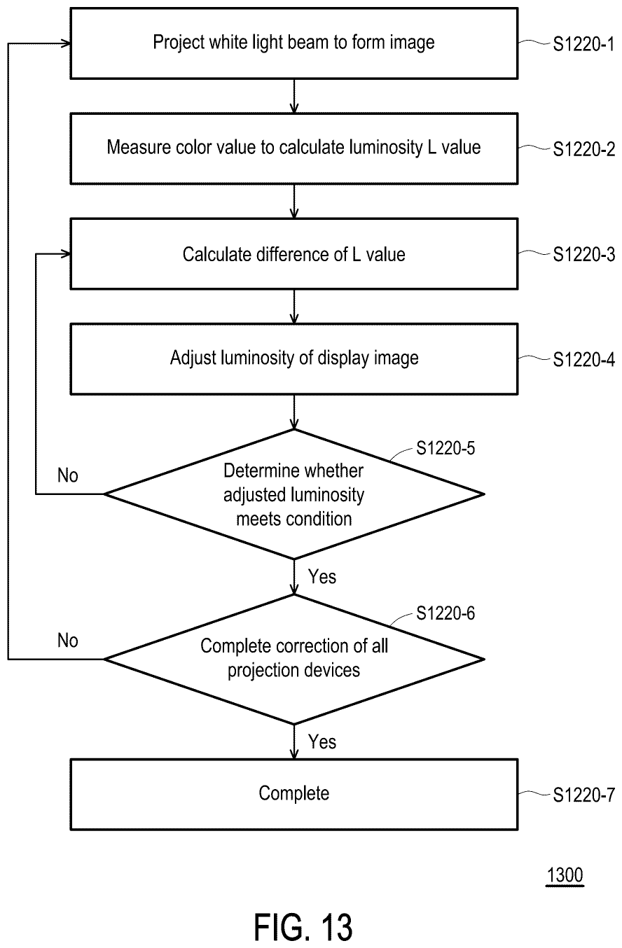

FIG. 13 is a schematic flowchart of a color correction operation according to an embodiment of the disclosure. Please refer to FIG. 10 to FIG. 13. A color correction operation 1300 of FIG. 13 is an implementation of step S1220 of the color correction operation 1200 in FIG. 12. The color correction operation 1300 includes step S1220-1 to step S1220-7. However, the disclosure is not limited thereto.

In step S1220-1, the processor of the computing device 1040 makes the projection device 1010 and the projection device 1020 project a white benchmark image light beam respectively, so as to form the target image BMK corresponding to the benchmark color and the display image SCN corresponding to the captured color on the projection target.

In step S1220-2, the measuring device 1030 measures the color value of the target image BMK and the color value of the display image SCN respectively to generate the benchmark color parameter value of the target image BMK and the color parameter value IMG of the display image SCN. The processor transforms the benchmark color parameter value and the color parameter value IMG into the Lab color space to calculate the luminosity (i.e., L value) corresponding to the benchmark color parameter value and the luminosity corresponding to the color parameter value IMG in the Lab color space.

In step S1220-3, the processor of the computing device 1040 calculates the luminosity difference according to the luminosity corresponding to the benchmark color parameter value and the luminosity corresponding to the color parameter value IMG.

In step S1220-4, the processor of the computing device 1040 generates a luminosity adjustment parameter value based on the luminosity difference and provides the luminosity adjustment parameter value to the projection device 1020 to adjust the current of the light source 610 of the projection device 1020, thereby changing the luminosity of the light source 610 and adjusting the target luminosity of the display image SCN.

In step S1220-5, the processor of the computing device 1040 determines whether the luminosity of the adjusted display image SCN meets the condition. For example, based on the color value of the target image BMK and the color value of the display image SCN after luminosity adjustment measured by the measuring device 1030, the processor determines whether the luminosity difference between the target image BMK and the display image SCN after luminosity adjustment is less than a predetermined luminosity threshold. If the result of the determination is yes (less than the luminosity threshold), step S1220-6 is performed. If the result of the determination is no (greater than or equal to the luminosity threshold), step S1220-3 is repeated.

In step S1220-6, the processor of the computing device 1040 determines whether the luminosity correction of all projection devices in the projection system 1000 is completed. If the result of the determination is yes (luminosity correction of all projection devices is completed), step S1220-7 is performed to complete the luminosity correction of the projection system 1000. If the result of the determination is no (luminosity correction of all projection devices is not completed), step S1220-1 is repeated to perform color correction on the projection devices for which the correction of the light source 610 is not completed.

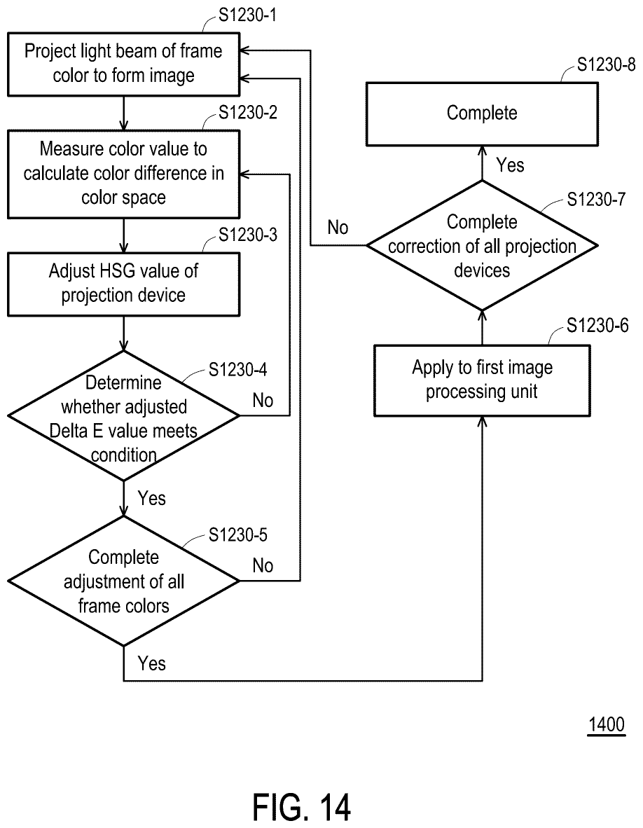

FIG. 14 is a schematic flowchart of a color correction operation according to an embodiment of the disclosure. Please refer to FIG. 10 to FIG. 14. A color correction operation 1400 of FIG. 14 is an implementation of step S1230 of the color correction operation 1200 in FIG. 12. The color correction operation 1400 includes step S1230-1 to step S1230-8. However, the disclosure is not limited thereto.

In step S1230-1, the processor of the computing device 1040 makes the projection device 1010 and the projection device 1020 project a benchmark image light beam of the same frame color respectively, so as to form the target image BMK corresponding to the benchmark color and the display image SCN corresponding to the captured color on the projection target.

In step S1230-2, the measuring device 1030 measures the color value of the target image BMK and the color value of the display image SCN respectively to generate the benchmark color parameter value of the target image BMK and the color parameter value IMG of the display image SCN. The processor transforms the benchmark color parameter value and the color parameter value IMG into the Lab color space to calculate the benchmark color parameter value (i.e., L value, a value, b value) and the color parameter value IMG in the Lab color space. In addition, the processor calculates the color difference (e.g., Delta E value) based on the benchmark color parameter value and the color parameter value IMG.

It should be noted that the Delta E value is used in the Lab color space to determine the difference between two colors, and this difference may be readily perceived by the human eye. Specifically, the Delta E value is defined as the distance between two coordinates in the Lab color space. For example, in the Lab color space, the coordinate values of the benchmark color are (L1, a1, b1), and the coordinate values of the captured color of the display image SCN are (L2, a2, b2). Taking the CIE76 standard as an example, the Delta E value between the two coordinates is √((L2−L1)²+(a2−a1)²+(b2−b1)²). In other embodiments, the CIE94 or CIEDE2000 standard may also be adopted to calculate the Delta E value, but is not limited thereto.

In step S1230-3, the processor of the computing device 1040 may generate the color adjustment parameter value ADJ based on the Delta E value (color difference) and provide the color adjustment parameter value ADJ to the projection device 1020 to adjust the target color (i.e., H value, S value, G value) of the display image SCN.

In step S1230-4, the processor of the computing device 1040 determines whether the adjusted Delta E value (color difference) between the target image BMK and the adjusted display image SCN meets the condition. For example, based on the color value of the target image BMK and the color value of the adjusted display image SCN measured by the measuring device 1030, the processor determines whether the adjusted Delta E value (color difference) between the target image BMK and the adjusted display image SCN are less than a predetermined color threshold. If the result of the determination is yes (the adjusted Delta E value is less than the color threshold), step S1230-5 is performed. If the result of the determination is no (the adjusted Delta E value is greater than or equal to the color threshold), step S1230-2 is repeated.

In step S1230-5, the processor of the computing device 1040 determines whether the color correction of all frame colors is completed. If the result of the determination is yes (all frame colors are completed), step S1230-6 is performed. If the result of the determination is no (other frame colors are not completed), step S1230-1 is repeated to perform color correction on the other frame colors that are not completed.

In step S1230-6, the processor of the computing device 1040 may apply the color adjustment parameter value ADJ obtained in step S1230-1 to step S1230-5 to the first image processing unit 640 of the projection device 1020, so that the first image processing unit 640 of the projection device 1020 may adjust the color of the display image SCN according to the color adjustment parameter value ADJ.

In step S1230-7, the processor of the computing device 1040 determines whether the color correction of the frame colors of all projection devices in the projection system 1000 is completed. When the determination result is yes (color correction of the frame colors of all projection devices is completed), step S1230-8 is performed to complete the color correction of the frame colors of the projection system 1000. If the result of the determination is no (color correction of the frame colors of all projection devices is not completed), step S1230-1 is repeated to perform color correction of the frame colors of the projection devices that are not completed.

It should be added that the target color defining the display image SCN may include the target frame color and the target global color. The target frame color includes red, green, blue, cyan, yellow, and magenta, and the target global color includes a plurality of color card colors of a color checker. As mentioned above, according to step S1220 to step S1240 of the color correction operation 1200 in FIG. 12, the color correction operation 1200 first adjusts the target luminosity of the display image. In response to the target luminosity finishing adjusting, an iteration computation is executed to adjust the target frame color of the display image; in response to the target frame color finishing adjusting, a matrix operation is executed to adjust the target global color of the display image.

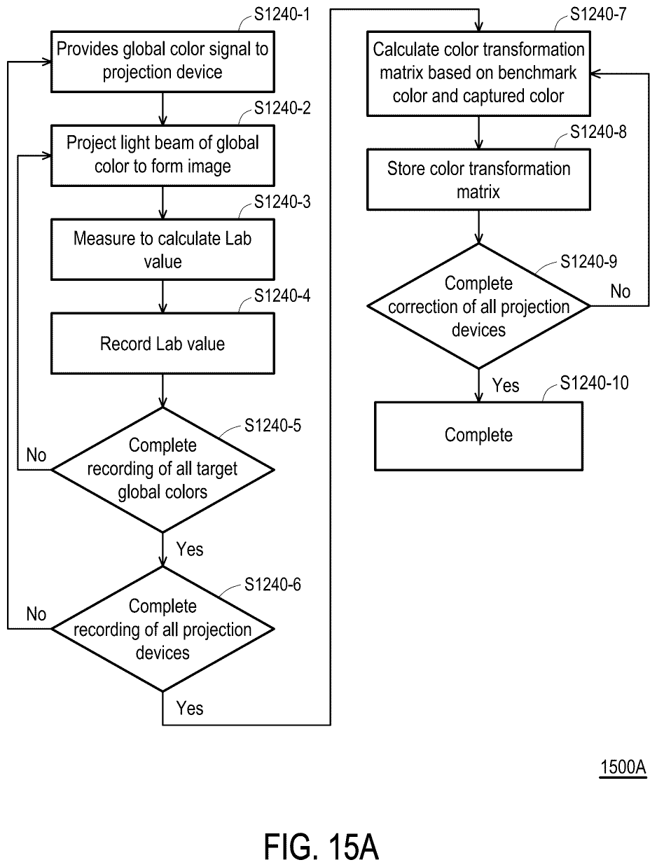

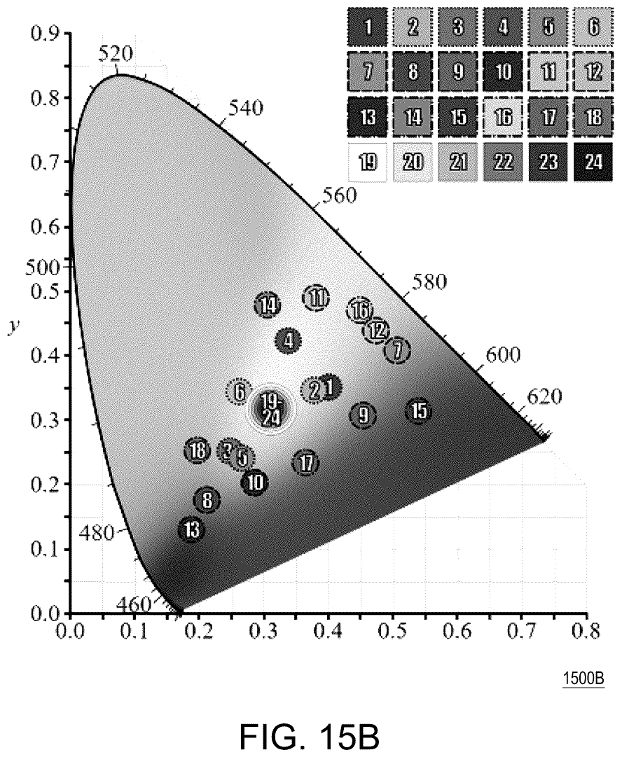

FIG. 15A is a schematic flowchart of a color correction operation according to an embodiment of the disclosure. Please refer to FIG. 10 to FIG. 15A. A color correction operation 1500A of FIG. 15A is an embodiment of step S1240 of the color correction operation 1200 in FIG. 12. The color correction operation 1500A includes step S1240-1 to step S1240-10. However, the disclosure is not limited thereto.

In step S1240-1, the processor of the computing device 1040 provides a color signal corresponding to the target global color (e.g., a plurality of color card colors of a color checker) to the projection device 1010 and the projection device 1020, and uses the plurality of color card colors as the benchmark color.

In step S1240-2, the processor of the computing device 1040 makes the projection device 1010 and the projection device 1020 project an image light beam of the same color card color, so as to form the display image SCN of the corresponding captured color on the projection target respectively. In particular, the plurality of color card colors correspond to the captured color.

In step S1240-3, the measuring device 1030 measures the color value of the display image SCN to generate the color parameter value IMG of the captured color corresponding to the plurality of color card colors. The processor transforms the color parameter value IMG by spatial transformation (transforms into Lab color space) to calculate the coordinate values of the captured color in Lab color space (i.e., L value, a value, b value).

In step S1240-4, the processor of the computing device 1040 records the coordinate values of the captured color (i.e., L value, a value, b value) calculated in step S1240-3.

In step S1240-5, the processor of the computing device 1040 determines whether the recording of all color card colors (i.e., global colors) is completed. If the result of the determination is yes (the recording of all color card colors is completed), step S1240-6 is performed. If the result of the determination is no (there are still other color card colors not recorded), step S1240-2 is repeated to project, measure, and record the global colors of the other color cards.

In step S1240-6, the processor of the computing device 1040 determines whether the projection, measurement, and recording of the global colors of all projection devices in the projection system 1000 are completed. If the result of the determination is yes (the recording of the global colors of all projection devices is completed), step S1240-7 is performed. If the result of the determination is no (there are still projection devices for which the recording of the global colors is not completed), step S1240-1 is performed to project, measure, and record the projection devices for which recording of the global colors is not completed.

In step S1240-7, the processor of the computing device 1040 executes a matrix operation based on the coordinate values of the benchmark colors corresponding to all global colors (a plurality of color card colors) and the coordinate values of the captured colors to generate a color transformation matrix. The color transformation matrix is a matrix transforming the captured color corresponding to the global color into the benchmark color corresponding to the global color. For example, a benchmark matrix B may include the L value, the a value, and the b value of the benchmark color corresponding to the global color, a captured matrix S may include the L value, the a value, and the b value of the captured color corresponding to the global color, and the color transformation matrix M may transform between the two. That is, B=S●M. In other words, the color transformation matrix M may be applied to the input of any of the L value, the a value, and the b value, thereby perform rapid correction and style matching. In an embodiment, the color transformation matrix M may be solved using the least squares method. However, the disclosure is not limited thereto.

In step S1240-8, the processor of the computing device 1040 stores the color transformation matrix M calculated in step S1240-7 as the color adjustment parameter value ADJ, and applies the color transformation matrix M to the second image processing unit 650 of the projection device, so that the second image processing unit 650 of the projection device may adjust the color of the display image SCN according to the color adjustment parameter value ADJ.

In step S1240-9, the processor of the computing device 1040 determines whether the color correction of the global colors of all projection devices in the projection system 1000 is completed. When the determination result is yes (color correction of the global colors of all projection devices is completed), step S1240-10 is performed to complete the color correction of the global color of the projection system 1000. If the result of the determination is no (color correction of the global colors of all projection devices is not completed), step S1240-7 is repeated to perform color correction of global color on the projection devices that are not completed. In an embodiment, after the target global color is finished adjusting, the computing device 1040 may store the color transformation matrix in the storage unit 680 of the projection device for access in a subsequent correction.

FIG. 15B is a schematic diagram of a color card according to an embodiment of the disclosure. Please refer to FIG. 10, FIG. 12, FIG. 15A, and FIG. 15B. A color card 1500B of FIG. 15B is an implementation of the global color of FIG. 12 and FIG. 15A. However, the disclosure is not limited thereto.

In an embodiment, in order to achieve the correction of global color quickly and accurately, the global color may consist of the 24 colors included in the color card 1500B. The 24 colors included in the color card 1500B are color checkers well-known to those in the art for color correction. In other words, after the 24 colors included in the color card 1500B are corrected, the colors between a plurality of projection devices may achieve a high degree of consistency in global color. In this way, by correcting a plurality of color card colors of the color checker, the colors between the plurality of projection devices may achieve consistency in global color, thereby improving viewing experience.

Based on the above, the user interface of the disclosure may display the coordinate values of the benchmark color and the coordinate values of the captured color represented by the color parameter value generated by the measuring device. Furthermore, through user operation of the user interface, the processor generates the color adjustment parameter value based on the coordinate values of the benchmark color and the coordinate values of the captured color, and provides the color adjustment parameter value to the projection device. In this way, the projected image formed by the projection of the projection device may display the target color desired by the user, thereby enhancing viewing experience.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of . . . and . . . ” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A non-transient processor-readable media, wherein the non-transient processor-readable medium is installed on a computing device and used to store an application program, and the computing device is communicatively connected to a projection device, and the computing device comprises a processor, the processor is used to execute the application program to implement a user interface, the user interface comprises a projection device information area, a benchmark color information area, a captured color information area, and a start option, wherein:
the projection device information area is used to display at least one projection device information, wherein the at least one projection device information comprises information of the projection device, and the projection device is used to project to form a display image on a projection target;
the benchmark color information area is used to display coordinate values of a benchmark color;
the captured color information area is used to display coordinate values of a captured color; and
the start option is used to receive a correction request, wherein in response to receiving a correction instruction from the user interface corresponding to the correction request, the processor generates a color adjustment parameter value according to the coordinate values of the benchmark color and the coordinate values of the captured color, and the computing device is used to provide the color adjustment parameter value to the projection device to adjust a target color of the display image.

2. The non-transient processor-readable media of claim 1, wherein
the at least one projection device information comprises a projection device list, wherein the projection device list is used to receive a specified projection device request, and in response to receiving the specified projection device request, the user interface provides a specified projection device instruction to the processor, and the processor is used to execute: setting a specified projection device as the projection device based on the specified projection device in the specified projection device instruction.

3. The non-transient processor-readable media of claim 2, wherein
the projection device information area also comprises an add projection device option, and the add projection device option is used to receive an add projection device request, and
in response to receiving the add projection device request, the user interface provides an add projection device instruction to the processor, and the processor is used to execute: adding another projection device to the projection device list based on the add projection device instruction.

4. The non-transient processor-readable media of claim 1, wherein the user interface further comprises: a measuring device information area used to display at least one measuring device information, and the at least one measuring device information comprises a measuring device list, wherein the measuring device list is used to receive a specified measuring device request, and in response to receiving the specified measuring device request, the user interface provides a specified measuring device instruction to the processor, and the processor is used to execute: setting a specified measuring device as the measuring device based on the specified measuring device in the specified measuring device instruction, wherein the coordinate values of the captured colors are measured by the measuring device and calculated by the processor.

5. The non-transient processor-readable media of claim 4, wherein the user interface further comprises a settings option, and in response to the settings option being triggered, a window is displayed, the window comprises a selection option, and in response to the selection option being in on status, a captured color input area automatically displays the coordinate values of the captured color, and the coordinate values of the captured color may not be changed, wherein the captured color input area is disposed in the captured color information area.

6. The non-transient processor-readable media of claim 4, wherein the user interface also comprises a settings option, in response to the settings option being triggered, a window is displayed, the window comprises a selection option, in response to the selection option being in off status, a captured color input area is used to input the coordinate values of the captured color, wherein the captured color input area is disposed in the captured color information area.

7. The non-transient processor-readable media of claim 1, wherein the benchmark color information area further comprises a target color input area, and the target color input area is used to display coordinate values of the target color.

8. The non-transient processor-readable media of claim 7, wherein
the user interface further comprises a benchmark color selection area, wherein the benchmark color selection area is used to receive a specified benchmark color request, and
in response to receiving the specified benchmark color request, the user interface provides a specified benchmark color instruction to the processor, and the processor is used to execute: modifying coordinate values of a specified benchmark color in the target color input area based on the specified benchmark color in the specified benchmark color instruction.

9. The non-transient processor-readable media of claim 1, wherein the benchmark color information area comprises at least white, red, green, blue, cyan, yellow, and magenta as the benchmark color.

10. A projection system, wherein the projection system comprises a projection device and a computing device, wherein:
the projection device is used to project to form a display image on a projection target; and
the computing device is communicatively connected to the projection device, and the computing device comprises a non-transient processor-readable medium and a processor, wherein:
the non-transient processor-readable media is used to store an application program;
the processor is used to execute the application program to implement a user interface, the user interface comprises a projection device information area, a benchmark color information area, a captured color information area, and a start option, wherein:
the projection device information area is used to display at least one projection device information, wherein the at least one projection device information comprises information of the projection device;
the benchmark color information area is used to display coordinate values of a benchmark color;
the captured color information area is used to display coordinate values of a captured color; and
the start option is used to receive a correction request, wherein in response to receiving the correction request, the user interface provides a correction instruction to the processor, and according to the correction instruction, the processor is used to generate a color adjustment parameter value according to the coordinate values of the benchmark color and the coordinate values of the captured color, and the computing device is used to provide the color adjustment parameter value to the projection device to adjust a target color of the display image.

11. The projection system of claim 10, wherein the at least one projection device information comprises a projection device list, wherein the projection device list is used to receive a specified projection device request, and in response to receiving the specified projection device request, the user interface provides a specified correction instruction to the processor, and the processor is used to execute: setting a specified projection device as the projection device based on the specified projection device in the specified projection device instruction.

12. The projection system of claim 11, wherein
the projection device information area also comprises an add projection device option, and the add projection device option is used to receive an add projection device request, and
in response to receiving the add projection device request, the user interface provides an add projection device instruction to the processor, and the processor is used to execute: adding another projection device to the projection device list based on the add projection device instruction.

13. The projection system of claim 10, wherein the projection system further comprises a measuring device communicatively connected to the computing device, the measuring device is used to obtain a color parameter value, so that the computing device calculates the coordinate values of the captured color according to the color parameter value, wherein the measuring device comprises a camera, a color difference meter, or a colorimeter.

14. The projection system of claim 13, wherein the user interface further comprises: a measuring device information area used to display at least one measuring device information, wherein the at least one measuring device information comprises a measuring device list, the measuring device list is used to receive a specified measuring device request, and in response to receiving the specified measuring device request, the user interface provides a specified measuring device instruction to the processor, and the processor is used to execute: setting a specified measuring device as the measuring device based on the specified measuring device in the specified measuring device instruction.

15. The projection system of claim 14, wherein the user interface further comprises a settings option, and in response to the settings option being triggered, a window is displayed, the window comprises a selection option, in response to the selection option being in on status, the captured color input area automatically displays the coordinate values of the captured color, and the coordinate values of the captured color may not be changed, wherein the captured color input area is disposed in the captured color information area.

16. The projection system of claim 14, wherein the user interface further comprises a settings option, and in response to the settings option being triggered, a window is displayed, the window comprises a selection option, in response to the selection option being in off status, a captured color input area is used to input the coordinate values of the captured color, wherein the captured color input area is disposed in the captured color information area.

17. The projection system of claim 10, wherein the benchmark color information area further comprises a target color input area, and the target color input area is used to display coordinate values of the target color.

18. The projection system of claim 17, wherein the user interface further comprises a benchmark color selection area, wherein the benchmark color selection area is used to receive a specified benchmark color request, and
in response to receiving the specified benchmark color request, the user interface provides a specified benchmark color instruction to the processor, and the processor is used to execute: modifying coordinate values of a specified benchmark color in the target color input area based on the specified benchmark color in the specified benchmark color instruction.

19. The projection system of claim 10, wherein
the projection system further comprises another projection device, and the another projection device is used as a benchmark projection device, and
the user interface is used to make the processor execute: using a captured color of the benchmark projection device as the benchmark color.

20. The projection system of claim 19, wherein the projection system further comprises a measuring device communicatively connected to the computing device, the measuring device is used to respectively obtain a benchmark color parameter value corresponding to the benchmark projection device and a color parameter value corresponding to the projection device, and transmit the benchmark color parameter value and the color parameter value to the processor of the computing device, wherein
according to the correction instruction, the processor is used to execute: performing a color space transformation on the benchmark color parameter value and the color parameter value to respectively generate the coordinate values of the captured color corresponding to the benchmark color parameter value and the coordinate values of the captured color corresponding to the color parameter value, and using the coordinate values of the captured color corresponding to the benchmark color parameter value as the coordinate values of the benchmark color.

21. The projection system of claim 20, wherein
in response to receiving the correction instruction, the processor is used to execute: generating a color difference based on the coordinate values of the captured color and the coordinate values of the benchmark color; and generating the color adjustment parameter value based on the color difference.

22. The projection system of claim 10, wherein the benchmark color comprises: white, red, green, blue, cyan, yellow, and magenta, wherein
in response to receiving the correction instruction, the processor is used to execute: adjusting the display image with white as the benchmark color; and in response to the white of the display image finishing adjusting, adjusting the display image using red, green, blue, cyan, yellow, and magenta as the benchmark color, respectively.

23. A projecting method, wherein the projecting method is adapted to a projection system, the projection system comprises a projection device, a benchmark projection device, a measuring device, and a computing device, and steps of the projecting method comprising:
forming a target image corresponding to a benchmark color on a projection target by a projection of the benchmark projection device;
forming a display image corresponding to a captured color on the projection target by a projection of the projection device;
generating a benchmark color parameter value corresponding to the target image and a color parameter value corresponding to the display image respectively by measuring the target image and the display image via the measuring device;
generating a luminosity adjustment parameter value based on a luminosity corresponding to the benchmark color parameter value and a luminosity corresponding to the color parameter value via the computing device in response to the benchmark color being white;
providing the luminosity adjustment parameter value to the projection device via the computing device to adjust a target luminosity of the display image;
generating a color adjustment parameter value based on the benchmark color parameter value and the color parameter value via the computing device in response to the benchmark color not being white; and
providing the color adjustment parameter value to the projection device via the computing device to adjust a target color of the display image.

24. The projecting method of claim 23, wherein in response to the benchmark color being white, the steps of the projecting method further comprise:
performing a color space transformation on the benchmark color parameter value and the color parameter value via the computing device to respectively generate coordinate values of the captured color corresponding to the benchmark color parameter value and coordinate values of the captured color corresponding to the color parameter value, and using the coordinate values of the captured color corresponding to the benchmark color parameter value as coordinate values of the benchmark color;
generating a luminosity difference based on the luminosity corresponding to the coordinate values of the captured color and the luminosity corresponding to the coordinate values of the benchmark color; and
generating the luminosity adjustment parameter value based on the luminosity difference.

25. The projecting method of claim 23, wherein the benchmark color is one of red, green, blue, cyan, yellow, and magenta.

26. The projecting method of claim 25, wherein in response to the benchmark color not being white, the steps of the projecting method further comprise:
performing a color space transformation on the benchmark color parameter value and the color parameter value via the computing device to respectively generate coordinate values of the captured color corresponding to the benchmark color parameter value and coordinate values of the captured color corresponding to the color parameter value, and using the coordinate values of the captured color corresponding to the benchmark color parameter value as coordinate values of the benchmark color;
generating a color difference based on the coordinate values of the captured color and the coordinate values of the benchmark color; and
generating the color adjustment parameter value based on the color difference.

27. The projecting method of claim 23, wherein
the target color comprises a target frame color and a target global color, wherein the target frame color comprises red, green, blue, cyan, yellow, and magenta, and the target global color comprises a plurality of color card colors,
and the steps of the projecting method further comprise:
adjusting the target frame color of the display image in response to the target luminosity finishing adjusting; and
adjusting the target global color of the display image in response to finishing adjusting the target frame color of the display image.

28. The projecting method of claim 27, wherein the steps thereof further comprise:
executing an iteration computation in response to the target luminosity finishing adjusting to adjust the target frame color of the display image; and
executing a matrix operation in response to the target frame color of the display image finishing adjusting to adjust the target global color of the display image.

29. The projecting method of claim 28, wherein in response to the target frame color of the display image finishing adjusting, the steps of the projecting method further comprise:
projecting the captured color corresponding to the plurality of color card colors respectively using the plurality of color card colors as the benchmark color to form the display image, and making the measuring device measure the display image to generate the color parameter value of the captured color corresponding to the plurality of color card colors;
performing a color space transformation on the color parameter value via the computing device to generate coordinate values of the captured color corresponding to the plurality of color card colors; and
executing the matrix operation based on coordinate values of the benchmark color corresponding to the plurality of color card colors and the coordinate values of the captured color corresponding to the plurality of color card colors via the computing device to generate a color transformation matrix as the color adjustment parameter value, wherein the color transformation matrix is used to transform the coordinate values of the captured color into the coordinate values of the benchmark color.

30. The projecting method of claim 29, wherein the steps thereof further comprise:
storing the color transformation matrix in a storage unit of the projection device in response to the target global color of the display image finishing adjusting.
